(19) United States
(12) Patent Application Publication
(10) Pub. No.: US 2026/0056486 A1
(43) Pub. Date: Feb. 26, 2026

(54) ELECTROPHOTOGRAPHIC ROLLER, PROCESS CARTRIDGE, AND ELECTROPHOTOGRAPHIC IMAGE FORMING APPARATUS

(71) Applicant: CANON KABUSHIKI KAISHA, Tokyo (JP)

(72) Inventors: YUKI NASUNO, Shizuoka (JP); YOSHITAKA SUZUMURA, Shizuoka (JP); ATSUSHI NOGUCHI, Shizuoka (JP)

(21) Appl. No.: 19/298,716

(22) Filed: Aug. 13, 2025

(30) Foreign Application Priority Data
Aug. 20, 2024 (JP) 2024-138958

(51) Int. Cl. G03G 15/02; C08G 18/44; C08G 18/48; C08G 18/79; C08K 3/04; C08L 75/04; C08L 75/08; G03G 5/147; G03G 15/08; G03G 21/18

(52) U.S. Cl. CPC G03G 15/0233; C08G 18/44; C08G 18/4829; C08G 18/4854; C08G 18/794; C08K 3/04; C08L 75/04; C08L 75/08; G03G 5/14704; G03G 5/14769; G03G 15/0808; G03G 21/1814; C08K 2201/001; C08L 2203/20; C08L 2312/00

(57) ABSTRACT

An electrophotographic roller having a conductive substrate and a resin layer on an outer peripheral surface of the substrate, wherein a thickness of the resin layer is 2.0 to 30.0 μm, the resin layer includes a binder resin and carbon black dispersed in the binder resin, an arithmetic mean value Rc of a circle-equivalent diameter of the carbon black in the resin layer is not more than 80 nm, an arithmetic mean value d of a distance between wall surfaces of the carbon black in the resin layer is 60 to 170 nm, and when an elastic modulus of the binder resin in a first region from an outer surface of the resin layer to a depth of 0.1 μm, measured in a cross section in a thickness direction of the resin layer, is defined as E1, E1 satisfies E1≥200 MPa.

### BACKGROUND

### Field of the Technology

The present disclosure relates to an electrophotographic roller, a process cartridge, and an electrophotographic image forming apparatus.

### Description of the Related Art

In an electrophotographic image forming apparatus (such as a copying machine, facsimile, or printer using an electrophotographic method), an image bearing member is charged by a charging roller, and an electrostatic latent image is formed by a laser. Next, a toner in a developing container is applied to a developing roller by a toner supply roller and a toner layer thickness control member, and development is performed by the toner when the image bearing member and the developing roller are in contact or in close proximity with each other. After that, the toner on the image bearing member is transferred to a recording paper by a transfer means, fixed by heat and pressure, and the toner remaining on the image bearing member is removed by a cleaning blade. With the demand for even longer life for electrophotographic image forming apparatuses in recent years, even greater durability is also required for electrophotographic rollers.

For example, when the durability life of an electrophotographic image forming apparatus becomes extremely long, the surface of a conventional developing roller may be worn down and scratched by repeated rubbing, and the functionality required for electrophotography may be impaired.

For example, in the case of a developing roller, the surface may be worn down and scratched by repeated rubbing. It is difficult to form high-quality electrophotographic images using such a developing roller. Furthermore, in the case of a charging roller, the occurrence of scratches may reduce the charging uniformity, and the electrophotographic image may become rough over time. In order to achieve continuous and stable output of high-quality electrophotographic images over a long period of time, an electrophotographic roller in which scratches due to abrasion are suppressed to a higher level, in other words, an electrophotographic roller with superior durability, is required.

In Japanese Patent Laid-Open No. 2020-008847, an interpenetrating polymer network structure (hereinafter referred to as an IPN structure) of a crosslinked urethane resin and a crosslinked acrylic resin is formed in the vicinity of the outer surface. This makes it possible to suppress scratches due to abrasion even during durable use with a large number of sheets printed in a high-temperature environment.

### SUMMARY

According to the study conducted by the present inventors, there is still room for improvement in the scratch resistance of the electrophotographic roller according to Japanese Patent Laid-Open No. 2020-008847. Specifically, for example, repeated use in high-temperature and low-temperature environments over a long period of time may cause scratches due to abrasion to propagate to the inside and become cracks.

The present disclosure provides an electrophotographic roller in which scratches due to abrasion and cracks caused by scratches propagating to the inside can be suppressed even during repeated use in high-temperature and low-temperature environments over a long period of time. The present disclosure also provides a process cartridge that contributes to the stable formation of high-quality electrophotographic images. The present disclosure also provides an electrophotographic image forming apparatus capable of forming high-quality electrophotographic images.

The present disclosure relates to an electrophotographic roller having a conductive substrate and a resin layer on an outer peripheral surface of the substrate, wherein a thickness of the resin layer is 2.0 to 30.0 μm, the resin layer comprises a binder resin and carbon black dispersed in the binder resin, an arithmetic mean value Rc of a circle-equivalent diameter of the carbon black in the resin layer is not more than 80 nm, an arithmetic mean value d of a distance between wall surfaces of the carbon black in the resin layer is 60 to 170 nm, and when an elastic modulus of the binder resin in a first region from an outer surface of the resin layer to a depth of 0.1 μm, measured in a cross section in a thickness direction of the resin layer, is defined as E1, E1 satisfies a following formula (1):

E1≥200 MPa (1).

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view showing an example of an electrophotographic roller according to the present disclosure.

FIG. 2 is a schematic cross-sectional view showing another example of an electrophotographic roller according to the present disclosure.

FIG. 3 is a schematic diagram of an electrophotographic image forming apparatus according to the present disclosure.

FIG. 4 is a schematic diagram of a process cartridge according to the present disclosure.

FIG. 5 is a cross-sectional view of an electrophotographic roller according to the present disclosure.

### DESCRIPTION OF THE EMBODIMENTS

In the present disclosure the notations “from XX to YY” and “XX to YY” representing a numerical value range signify, unless otherwise specified, a numerical value range that includes the lower limit and the upper limit of the range, as endpoints. In a case where numerical value ranges are described in stages, the upper limits and the lower limits of the respective numerical value ranges can be combined arbitrarily. In the present disclosure, for instance, a wording such as “at least one selected from the group consisting of XX, YY and ZZ” encompasses XX, YY and ZZ, a combination of XX and YY, a combination of XX and ZZ, a combination of YY and ZZ, and a combination of XX, YY and ZZ.

According to the study by the present inventors, the electrophotographic roller according to Japanese Patent Laid-Open No. 2020-008847 has room for improvement in terms of scratch resistance when used in a low-temperature environment. Specifically, for example, repeated use in high-temperature and low-temperature environments over a long period of time may cause scratches due to abrasion to propagate to the inside and become cracks.

The electrophotographic roller according to Japanese Patent Laid-Open No. 2020-008847 exhibits strength and flexibility as a result of forming an IPN structure of a crosslinked urethane resin and a crosslinked acrylic resin in the vicinity of the outer surface. In the IPN structure, two or more polymer mesh structures are intertwined and entangled with each other without being covalently bonded. In an embodiment according to Japanese Patent Laid-Open No. 2020-008847, the crosslinked acrylic resin having a higher elastic modulus than the crosslinked urethane resin serves as the second polymer to form a mesh for the crosslinked urethane. As a result, scratches due to abrasion can be suppressed during durable use with a large number of sheets printed in a high-temperature environment.

However, the IPN structure of crosslinked urethane resin and crosslinked acrylic resin may lose toughness and become embrittled in a low-temperature environment, and scratches that have already occurred may propagate to the inside and become cracks.

As a result of extensive investigations, the inventors have concluded that in order to obtain an electrophotographic roller in which the occurrence of scratches and cracks due to abrasion during repeated use in high-temperature and low-temperature environments over a long period of time can be suppressed, it is necessary to simultaneously satisfy the following two requirements.

### Requirement (1)

When an elastic modulus of the binder resin in a first region from the outer surface of the resin layer to a depth of 0.1 μm, which is measured in a cross section in the thickness direction of the resin layer of the electrophotographic roller, is denoted by E1, E1 satisfies the following formula (1).

$$E 1 \geq 200 MPa . \qquad ( 1 )$$

### Requirement (2)

The resin layer of the electrophotographic roller contains a binder resin and carbon black dispersed in the binder resin. The arithmetic mean value Rc of the circle-equivalent diameter of the carbon black in the resin layer is 80 nm or less, and the arithmetic mean value d of a distance between wall surfaces of the carbon black in the resin layer is 60 nm to 170 nm.

The above requirements (1) and (2) are explained in detail below.

### Technical Significance of Requirement (1)

Requirement (1) specifies the elastic modulus in the region from the outer surface of the electrophotographic roller to a depth of 0.1 μm. A high elastic modulus in this region indicates a high hardness of the outermost surface of the electrophotographic roller. Since resin materials generally soften in high-temperature environments, frictional force is higher in high-temperature environments than in normal temperature environments. Where an electrophotographic roller with a resin layer with a low elastic modulus is used for a long period of time in such high-temperature environment, scratches due to abrasion will occur.

The elastic modulus E1 is 200 MPa or more, preferably 250 MPa or more, and more preferably 400 MPa or more. There is no particular upper limit, but the elastic modulus E1 is, for example, 600 MPa or less and 550 MPa or less. The elastic modulus E1 is preferably 200 MPa to 600 MPa, more preferably 250 MPa to 600 MPa, and even more preferably 400 MPa to 600 MPa.

By setting the elastic modulus E1 in this range, it is possible to suppress the occurrence of scratches due to abrasion at an extremely high level even when the roller is used for a long period of time in a high-temperature environment.

### Technical Significance of Requirement (2)

Requirement (2) specifies the dispersibility of carbon black contained in the resin layer of the electrophotographic roller. In electrophotographic rollers, a method of dispersing carbon black in the resin layer to obtain conductivity has been suitably used. It is highly probable that the aforementioned cracks occur in low-temperature environments in which the toughness of the resin layer decreases by propagating from the scratches as initiation points along the resin-carbon black interface. As a result of extensive investigations, the inventors have found that by dispersing carbon black to a high degree in the resin layer, it is possible to suppress the propagation of scratches along the resin-carbon black interface.

By increasing the elastic modulus in the region from the outer surface to a depth of 0.1 μm to 200 MPa or more according to requirement 1, it is possible to suppress the occurrence of scratches due to abrasion to an extremely high level. Meanwhile, in a low-temperature environment, the toughness is likely to decrease in the region from the outer surface to a depth of 0.1 μm, so that scratches that have occurred will propagate deeper and cracks will occur.

In the present disclosure, the arithmetic mean value Rc of the circle-equivalent diameter of the carbon black in the resin layer is 80 nm or less, and the arithmetic mean value d of the distance between the wall surfaces of the carbon black in the resin layer is 60 nm to 170 nm. Where Rc and d are set in the above ranges, scratches are less likely to propagate to the inside even in a resin layer with reduced toughness, and the occurrence of cracks can be suppressed.

Scratches propagate along the carbon black-resin layer interface. Therefore, it is conceivable that where Rc is outside the above range, the carbon black-resin layer interface is likely to be continuous, and scratches are likely to propagate. Also, where d is less than 60 nm, adjacent carbon black particles are close to each other, and scratches are likely to propagate along them. Where d exceeds 170 nm, adjacent carbon black particles are too far apart, and it is thought that good electric conductivity of the resin layer is difficult to obtain.

The arithmetic mean value Rc of the circle-equivalent diameter is preferably 60 nm or less. Rc is, for example, 30 nm to 80 nm, preferably 40 nm to 65 nm, more preferably 40 nm to 60 nm, and even more preferably 50 nm to 60 nm.

The arithmetic mean value d of the distance between the wall surfaces is preferably 80 nm to 150 nm, and more preferably 100 nm to 130 nm. By setting this value within the above ranges, it is easier to suppress the occurrence of scratches and cracks.

In order to obtain the effects of the present disclosure, it is important to simultaneously satisfy the above requirements. By simultaneously satisfying requirements (1) and (2), scratches due to abrasion and cracks caused by scratches propagating to the inside can be suppressed even in repeated use in high-temperature and low-temperature environments for a long period of time. Where requirement (1) is not satisfied, scratches due to abrasion cannot be suppressed, and where requirement (2) is not satisfied, cracks caused by scratches propagating to the inside cannot be suppressed. Selection of suitable materials and manufacturing conditions for satisfying requirements (1) and (2) will be described below.

The present disclosure will be described in detail below.

### Electrophotographic Roller

The electrophotographic roller has a conductive substrate and a resin layer on the outer peripheral surface of the substrate. The resin layer is at least one layer and may be a single layer. It is preferable that the resin layer form the outer surface of the electrophotographic roller. The substrate and the resin layer may be in direct contact with each other, or another layer may be present between the substrate and the resin layer.

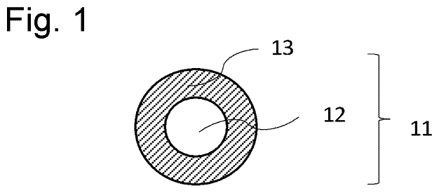

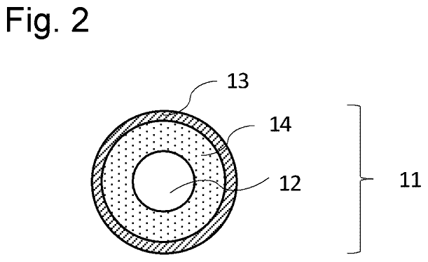

An example of an electrophotographic roller is shown in FIG. 1. In an electrophotographic roller 11 shown in FIG. 1, a resin layer 13 is laminated on the outer peripheral surface of a round rod-shaped or hollow cylindrical substrate 12. The layer configuration of the electrophotographic roller is not limited to that shown in FIG. 1. As another form of electrophotographic roller, FIG. 2 exemplifies an electrophotographic roller having an intermediate layer 14 between the substrate 12 and the resin layer 13 provided on the outer peripheral surface thereof.

### Substrate

The substrate is conductive and functions as a support member for the electrophotographic roller, and in some cases as an electrode. Specific examples of the substrate are preferably solid round rod-shaped or hollow cylindrical substrates.

The material constituting the substrate can be selected, as appropriate, from those known in the field of conductive members for electrophotography and materials usable as electrophotographic rollers. Examples include metals or alloys such as aluminum and stainless steel, carbon steel alloys, conductive synthetic resins, iron, and copper alloys.

Furthermore, the material constituting the substrate may be subjected to oxidation treatment or plating treatment with chromium, nickel, or the like. As the type of plating, either electroplating or electroless plating can be used. From the viewpoint of dimensional stability, electroless plating is preferred. The types of electroless plating used here include nickel plating, copper plating, gold plating, and various other alloy plating. The plating thickness is preferably 0.05 μm or more, and considering the balance between work efficiency and rust prevention ability, the plating thickness is preferably 0.1 μm to 30 μm.

A primer may be applied to the surface of the substrate to improve adhesion between the substrate and the resin layer. As the primer, a known one can be selected and used depending on the rubber material for forming the conductive layer and the material of the support. As the primer material, for example, thermosetting resins and thermoplastic resins can be mentioned, and specifically, materials such as phenolic resins, polyurethanes, acrylic resins, polyester resins, polyether resins, and epoxy resins can be used.

In a non-magnetic one-component contact development process, an electrophotographic roller in which the intermediate layer 14 is laminated between the substrate 12 and the resin layer 13 can be suitably used. The intermediate layer is preferably formed of a molded body of a usual rubber material.

Examples of rubber materials include the following: ethylene-propylene-diene copolymer rubber (EPDM), acrylonitrile-butadiene rubber (NBR), chloroprene rubber (CR), natural rubber (NR), isoprene rubber (IR), styrene-butadiene rubber (SBR), fluororubber, silicone rubber, epichlorohydrin rubber, hydrogenated NBR, and urethane rubber. These can be used alone or in combination of two or more.

### Resin Layer

### Binder Resin

The resin layer contains a binder resin. A known binder resin can be used as the binder resin. It is preferable that the binder resin contains a crosslinked urethane resin, which has excellent flexibility and strength and makes it easier to form the IPN structure described below.

The urethane resin can be obtained from urethane raw materials containing a polyol, an isocyanate, and, if necessary, a chain extender. The urethane resin may be a cured product of urethane raw materials, or a cured product of a mixture of urethane raw materials containing urethane raw materials and additives such as a surface modifier and roughness-forming particles. Examples of polyols that are raw materials for urethane resins include polyether polyols, polyester polyols, polycarbonate polyols, polyolefin polyols, acrylic polyols, and mixtures thereof. Among the above, polycarbonate polyols are preferred.

Examples of isocyanates that are raw materials for urethane resins include the following: tolylene diisocyanate (TDI), diphenylmethane diisocyanate (MDI), naphthalene diisocyanate (NDI), tolidine diisocyanate (TODI), hexamethylene diisocyanate (HDI), isophorone diisocyanate (IPDI), phenylene diisocyanate (PPDI), xylylene diisocyanate (XDI), tetramethylxylylene diisocyanate (TMXDI), cyclohexane diisocyanate, polymeric MDI, and mixtures thereof.

Among the above, polymeric MDI is preferred. Polymeric MDI, as referred to herein, is a mixture of monomeric MDI and a high molecular weight polyisocyanate, and is represented by the following formula (A). In formula (A), n is preferably from 0 to 4.

Commercially available polymeric MDI may be used, and examples thereof include Millionate MR series (manufactured by Tosoh Corporation) such as Millionate MR400 (product name).

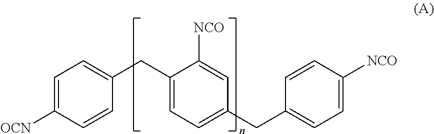

Chain extenders, which are raw materials for urethane resin, can be exemplified by bifunctional low molecular weight diols such as ethylene glycol, 1,4-butanediol, and 3-methylpentanediol, trifunctional low molecular weight triols such as trimethylolpropane, and mixtures thereof. Prepolymer-type isocyanate compounds having isocyanate groups at the ends, which are obtained by reacting the above-mentioned various isocyanate compounds with various polyols in a state where the isocyanate groups are in excess, may also be used. As these isocyanate compounds, materials in which the isocyanate groups are blocked with various blocking agents such as MEK oxime may also be used.

Whether any of the materials is used, a urethane resin can be obtained by reacting the polyol with the isocyanate by heating. In addition, when either or both of the polyol and the isocyanate have a branched structure and have three or more functional groups, the resulting urethane resin becomes a crosslinked urethane resin.

Furthermore, from the viewpoint of the elastic modulus of the resin layer, it is preferable that the binder resin contains a crosslinked urethane resin having a polycarbonate structure. By using a crosslinked urethane resin having a polycarbonate structure, E1 and E2 can be easily controlled within a suitable range.

It is possible to confirm that the polymer contained in the resin layer of the electrophotographic roller is a crosslinked urethane resin having a polycarbonate structure, for example, by analysis using pyrolysis GC/MS, FT-IR, or NMR.

### Crosslinked (Meth)Acrylic Resin

The crosslinked (meth)acrylic resin (hereinafter may be simply referred to as “crosslinked acrylic resin”) is harder than the crosslinked urethane resin, so it is possible to increase the hardness of the outermost surface. However, the crosslinked acrylic resin is brittle when used alone and is prone to scratches due to abrasion caused by friction. Meanwhile, when an IPN structure, which will be described hereinbelow, is introduced to the outer surface or in the vicinity of the outer surface of the resin layer, brittleness is unlikely to occur, and high strength can be imparted while maintaining flexibility.

The resin layer preferably contains a crosslinked urethane resin and a crosslinked acrylic resin. The resin layer preferably contains a crosslinked urethane resin as a binder resin. In the resin layer, the crosslinked urethane resin and the crosslinked acrylic resin preferably form an interpenetrating polymer network structure (IPN structure).

The IPN structure is defined as a structure in which the mesh structures of two or more polymer compounds are intertwined and entangled with each other without being linked by covalent bonds. The IPN structure in the resin layer is preferably formed by the incorporation of the crosslinked acrylic resin into the mesh of the three-dimensional crosslinked structure of the crosslinked urethane resin.

The crosslinked acrylic resin is formed by the polymerization of (meth)acrylic monomers. The (meth)acrylic monomers referred to herein mean acrylic monomers and methacrylic monomers. In other words, the crosslinked acrylic resin is formed by the polymerization of either or both of the acrylic monomers and methacrylic monomers.

In order for the crosslinked acrylic resin to form an IPN structure with the crosslinked urethane resin on the outer surface and in the vicinity of the outer surface of the resin layer, it is preferable to impregnate the resin layer containing the crosslinked urethane with liquid (meth)acrylic monomers and then perform curing.

The types of (meth)acrylic monomers used here include polyfunctional monomers having a plurality of acryloyl or methacryloyl groups as functional groups in order to form a crosslinked structure. Meanwhile, where the number of functional groups is four or more, the viscosity of the (meth)acrylic monomer increases, making it difficult for the monomer to penetrate into the surface of the resin layer made of crosslinked urethane resin, and as a result, it is difficult to form an IPN structure. Therefore, the (meth)acrylic monomer is preferably a monomer in which the total number of acryloyl groups and methacryloyl groups present in one molecule is two or three, and more preferably a bifunctional (meth)acrylic monomer in which the total number is two. Monofunctional monomers may also be combined as necessary.

The bifunctional (meth)acrylic monomer is preferably at least one selected from the group consisting of alkylene glycol di(meth)acrylate and alkylene oxide (ethylene oxide, propylene oxide) modified products of alkylene glycol di(meth)acrylate. For example, propylene oxide-modified neopentyl glycol diacrylate can be mentioned.

Examples of trifunctional (meth)acrylic monomers include trimethylolpropane tri(meth)acrylate and pentaerythritol tri(meth)acrylate.

The molecular weight of the (meth)acrylic monomer is preferably in the range of from 200 to 750. By using a molecular weight in this range, an IPN structure is easily formed in the network structure of the crosslinked urethane resin, and the strength of the resin layer can be effectively improved.

The content of the crosslinked acrylic resin in the resin layer relative to 100 parts by mass of the crosslinked urethane resin is preferably 3 parts by mass to 20 parts by mass, and more preferably 5 parts by mass to 15 parts by mass.

As mentioned above, the (meth)acrylic monomer is impregnated into the resin layer containing the crosslinked urethane resin. For this purpose, the (meth)acrylic monomer has an appropriate viscosity. That is, impregnation is difficult with a high viscosity, and control of the impregnation state is difficult with a low viscosity. Therefore, the viscosity of the (meth)acrylic monomer is preferably from 5.0 mPa·s to 140 mPa·s at 25° C. That is, one or two or more types of (meth)acrylic monomers satisfying the above-mentioned molecular weight and viscosity ranges are selected, impregnated into the resin layer, and polymerized to form an IPN structure of the crosslinked urethane resin and the crosslinked acrylic resin.

The polymerization method of the (meth)acrylic monomer is not particularly limited, and known methods can be used. Specifically, methods such as heating and ultraviolet irradiation can be mentioned. For each polymerization method, known radical polymerization initiators and ionic polymerization initiators can be used. These polymerization initiators may be used alone or in combination of two or more types.

Known heating devices and ultraviolet irradiation devices can be used as appropriate. As light sources for irradiating ultraviolet rays, for example, LED lamps, high-pressure mercury lamps, metal halide lamps, xenon lamps, and low-pressure mercury lamps can be used. The accumulated light quantity required for polymerization can be adjusted, as appropriate, depending on the compounds used and the types and amounts of polymerization initiators added.

### Surface Modifier

In addition to the crosslinked urethane resin, the resin layer can contain a surfactant such as a modified silicone compound and a modified fluorine compound. The surfactant can have both a low-polarity group such as a silicone-containing group or a fluorine-containing group, and a high-polarity group at the modified site. It is preferable to include the surface modifier in the urethane raw material mixture that forms the crosslinked urethane resin.

Due to a large difference in polarity between the urethane group or other high-polarity group of the crosslinked urethane resin and the low-polarity group such as a silicone-containing group or a fluorine-containing group in the surfactant molecule, the surfactant migrates to and remains in the vicinity of the outer surface of the resin layer. Furthermore, when the (meth)acrylic monomer and the polymerization initiator are swelled from the outer surface of the crosslinked urethane resin containing the surfactant, the (meth)acrylic monomer remains near the surfactant where a (meth)acrylic monomer that has a small difference in polarity with the high-polarity group in the surfactant molecule is used. In other words, since the (meth)acrylic monomer is cured while remaining near the outer surface, it becomes easier to locally form an IPN structure on the outer surface of the resin layer and in the vicinity of the outer surface.

### Carbon Black

The resin layer contains a binder resin and carbon black dispersed in the binder resin. Carbon black is dispersed in the resin layer to obtain electrical conductivity. Furthermore, in order to facilitate higher dispersion in the resin layer, carbon black with a number-average diameter of primary particles of 30 nm or less, a DBP absorption amount of 90 mL/100 g or less, and pH of 4.0 or less is preferred.

When the number-average diameter of primary particles of carbon black is 30 nm or less and the DBP absorption amount is 90 mL/100 g or less, the aggregates (primary agglomerates), which are the smallest dispersible units of carbon black, become smaller, and the structure (size of particle connections) also becomes smaller, making it easier to reduce the circle-equivalent diameter Rc described below.

A lower number-average diameter is preferable, and there is no particular lower limit. For example, the number-average diameter of primary particles of carbon black is 5 nm to 30 nm, and more preferably 20 nm to 30 nm. The primary particle diameter of carbon black can be calculated using a transmission electron microscope (TEM).

A lower DBP absorption amount is preferable, and there is no particular lower limit. For example, the DBP absorption amount of carbon black is more preferably 30 to 90 mL/100 g, and 40 to 80 mL/100 g.

When the pH of carbon black is 4.0 or less, the repulsion of the functional groups at the surface of carbon black makes it difficult for carbon black to aggregate. Therefore, the effect of dispersion stability is obtained. A lower pH of carbon black is preferable, and there is no particular lower limit. For example, the pH of carbon black is more preferably 2.0 to 4.0, and 2.2 to 3.6.

However, even if the number-average diameter, DBP absorption amount, and pH of the primary particles of carbon black are within the above ranges, where polycarbonate urethane is used as the binder resin, carbon black may not be fully dispersed, and the desired dispersion state may not be obtained. The reason why carbon black, which has the desired raw material properties, cannot be dispersed when polycarbonate urethane is used as the binder resin is not clearly understood, but is presumed to be as follows.

The hydroxyl group, which is the surface functional group of carbon black, easily interacts with the terminal hydroxyl group of polycarbonate diol. Meanwhile, the structure which is present between the two hydroxyl groups of polycarbonate diol and in which the carbonate bond and the hydrocarbon group are bonded to each other is hydrophobic due to the presence of the hydrocarbon group and does not easily interact with carbon black. Configurations in which hydrophobic is close to hydrophobic, and hydrophilic is close to hydrophilic are structurally more stable, so hydrophilic carbon black is present in the vicinity of carbon black which is also hydrophilic. It is considered that, as a result, carbon black is likely to aggregate and is difficult to disperse.

In order to fully disperse carbon black with the number average diameter of primary particles, DBP absorption amount, and pH in the above numerical ranges when polycarbonate urethane is used as the binder resin, it is more preferable to add the additives described below.

Considering the reinforcing performance and electrical conductivity of the resin layer, the carbon black content is preferably 5 parts by mass to 45 parts by mass, more preferably 20 parts by mass to 40 parts by mass, per 100 parts by mass of the binder resin forming the resin layer. Where the content exceeds 45 parts by mass, the distance between the carbon black particles in the coating material liquid is appropriately maintained, the probability of collision due to the Brownian motion of the carbon black is reduced, and the carbon black is less likely to aggregate. Therefore, the carbon black is easily dispersed, and the dispersion stability is also improved. As a result, the carbon black is well dispersed in the resin layer formed by forming a film from the coating material liquid.

It is necessary that the arithmetic mean value Rc of the circle-equivalent diameter of the carbon black in the resin layer be 80 nm or less, and the arithmetic mean value d of the distance between the wall surfaces of the carbon black in the resin layer be 60 nm to 170 nm. Furthermore, it is preferable that the arithmetic mean value Rc of the circle-equivalent diameter be 60 nm or less. It is also preferable that the arithmetic mean value d of the distance between the wall surfaces be 80 nm to 150 nm.

When the above-mentioned numerical ranges for the circle-equivalent diameter and the distance between the wall surfaces are used, scratches are unlikely to propagate to the inside of the resin layer in which the IPN structure is formed in a low-temperature environment, and the occurrence of cracks can be suppressed. Where the arithmetic mean value Rc of the circle-equivalent diameter exceeds 80 nm, scratches are likely to propagate along the resin-carbon black interface, and where the arithmetic mean value d of the distance between the wall surfaces is less than 60 nm, adjacent carbon black particles are likely to come into close contact with each other and scratches are likely to propagate. Furthermore, where d exceeds 170 nm, it is difficult to obtain proper conductivity.

Where the standard deviation of the circle-equivalent diameter is denoted by σc, σc/Rc is, for example, 0.000 to 0.730, preferably 0.000 to 0.650, and more preferably 0.500 to 0.650.

The arithmetic mean value Rc and standard deviation σc of the circle-equivalent diameter can be changed, for example, by the dispersion state in a mill or the like when preparing the resin layer coating material. Weaker dispersion tends to increase Rc and σc, and stronger dispersion tends to decrease Rc and σc. Normally, Rc converges, so once a certain dispersion state is exceeded, σc can be reduced while Rc remains almost constant, and σc/Rc can be reduced.

Where the standard deviation of the distance between the wall surfaces is denoted by σd, σd/d is, for example, 0.000 to 0.680, preferably 0.000 to 0.600, and more preferably 0.500 to 0.600.

By keeping σc/Rc and σd/d within the above ranges, scratches and cracks can be more easily suppressed.

The arithmetic mean value d and standard deviation σd of the distance between the wall surfaces can be changed, for example, by the dispersion state in a mill or the like when preparing the resin layer coating material. Weaker dispersion tends to decrease d and increase σd, while stronger dispersion tends to increase d and decrease σd. Therefore, weaker dispersion tends to increase σd/d, and stronger dispersion tends to decrease ød/d.

Multiple types of carbon black may be used in combination, as long as the dispersion state of the carbon black satisfies the above-mentioned regulations.

### Resin Particles

Resin particles may be added to the resin layer in order to form protrusions on the surface of the electrophotographic roller. When the resin layer is to have surface roughness, fine particles for imparting roughness to the resin layer can be included. Specifically, fine particles of polyurethane resin, polyester resin, polyether resin, polyamide resin, acrylic resin, and polycarbonate resin can be used. These are also preferably crosslinked resin particles.

When an IPN structure is formed at the outer surface side of the resin layer, an IPN structure may also be formed inside the crosslinked resin particles. The volume-average particle diameter of the fine particles is preferably from 1.0 μm to 30 μm. The surface roughness (ten-point average roughness) Rzjis formed by the fine particles is preferably from 0.1 μm to 20 μm. Rzjis is a value measured based on JIS B0601 (1994).

### Additives

Additives are preferably used to further improve the dispersibility of carbon black in the binder resin using polycarbonate urethane. The additives make it easier to set Rc, d, σc/Rc, and σd/d within the above ranges. Here, as an additive, the resin layer preferably contains at least one compound selected from the group consisting of a compound having a structure represented by the following structural formula (2), a compound having a structure represented by the following structural formula (3), and a compound having a structure represented by the following structural formula (4). One method for incorporating the additives in the resin layer is to include a dispersing agent in the resin layer coating material. In the resin layer formed using a resin layer coating material containing at least one compound selected from the group consisting of a compound having a structure represented by structural formula (2) and a compound having a structure represented by structural formula (3), the compound may be incorporated at the end of the polyurethane polymer chain. Even in such a case, the effect of improving the dispersibility of carbon black can be expected, but it is preferable that the additive be present in the resin layer independently of the polyurethane.

Among these, structural formula (2) is more preferred because particularly excellent carbon black dispersibility and affinity with polycarbonate urethane can be achieved. By satisfying the above, it becomes easier to achieve the above-mentioned carbon black dispersion state, and it becomes easier to set Rc, d, σc/Rc, and σd/d in the above ranges.

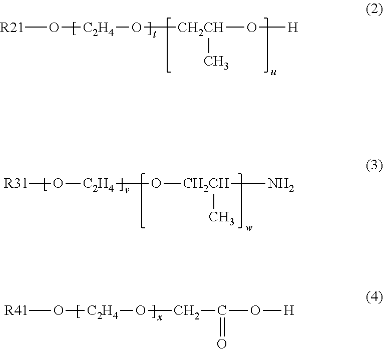

In structural formula (2), R21 represents a monovalent hydrocarbon group having 1 to 12 carbon atoms (preferably 3 to 12). t and u are the average numbers of moles added, each of which independently represents a number of 1 or more (preferably 5 to 30, more preferably 10 to 25).

In structural formula (3), R31 represents a monovalent hydrocarbon group having 1 to 8 carbon atoms (preferably 1 to 4). v and w represent the average number of moles added, each of which independently represents a number of 1 or more (preferably 1 to 30, more preferably 5 to 30).

In structural formula (4), R41 represents a monovalent hydrocarbon group having 1 to 12 carbon atoms. x is the average number of moles added and x and represents a number of 1 or more (preferably 1 to 30, more preferably 4 to 15).

Structural formula (2) is a polyoxyethylene polyoxypropylene alkyl ether, a polyether monool having a structure obtained by addition polymerization of ethylene oxide and propylene oxide in a block form. The terminal hydroxyl groups of this polyether monool interact with the surface functional groups of carbon black, which is a conductive filler, through hydrogen bonding and act as a dispersing agent for the carbon black. In addition, the obtained structure has good compatibility with polycarbonate urethane to enhance the effect of carbon black as a dispersing agent.

Ethylene oxide is introduced into the structure to ensure that the additives are present uniformly in the polycarbonate urethane. This is thought to be because the ethylene group in ethylene oxide has good compatibility with the hydrophobic hydrocarbon groups in the polycarbonate urethane. In addition, propylene oxide is introduced into the structure to improve the dispersibility of the carbon black dispersed in the resin layer. This is thought to be because the side-chain methyl group of propylene oxide interacts with the carbon black, improving the dispersibility of the carbon black.

R21, which is a monovalent hydrocarbon group having 1 to 12 carbon atoms, is introduced into the structure to ensure that the additives are uniformly present in the polycarbonate urethane. This monovalent hydrocarbon group has good compatibility with the hydrophobic hydrocarbon group in the polycarbonate urethane and can ensure that the additives are uniformly present in the polycarbonate urethane. Since the number of carbon atoms is 12 or less, a steric hindrance with the polycarbonate urethane is unlikely to occur, making it easier for the additives to be uniformly present.

Because the compound of structural formula (2) has a monool structure, it is less reactive than a diol, and is less likely to participate in the urethane reaction caused by the reaction of isocyanate with polyol.

Polyoxyethylene polyoxypropylene alkyl ethers can be commercially available products or can be obtained by synthesis. The synthesis of polyoxyethylene polyoxypropylene alkyl ether can be performed by carrying out step (B) after step (A) below. Step (B) may also be carried out on a commercially available product having a structure obtained by completing step (A).
Step (A): Reaction of alcohol with ethylene oxide.
Step (B): Reaction of the product obtained in step (A) with propylene oxide.

Step (A) can be carried out by adding ethylene oxide to alcohol in the presence of a catalyst at 50° C. to 200° C., more preferably 100° C. to 160° C. Since ethylene oxide has a boiling point of 10.7° C. and is a gas at the above temperature, it is preferable to carry out the reaction in a pressurized environment in a sealed container. The pressure is preferably 0.1 MPa to 1.0 MPa. The reaction time is not particularly limited, but it is preferably about 1 h to 3 h in order to reduce the amount of unreacted ethylene oxide.

As the catalyst, an acid catalyst or an alkali catalyst can be used, but an alkali catalyst is preferable in order to facilitate purification after completion of the reaction. Examples of the alkali catalyst include hydroxides of alkali metals such as sodium hydroxide and potassium hydroxide, hydroxides of alkaline earth metals such as calcium hydroxide and barium hydroxide, ammonium hydroxide, and tertiary amines. In view of the ease of reaction and reaction efficiency, sodium hydroxide and potassium hydroxide are particularly preferred. Examples of the acid catalyst include Bronsted acids such as sulfuric acid and phosphoric acid, and Lewis acids such as stannic chloride and boron trifluoride.

The amount of catalyst used is preferably 0.1 mol % to 5 mol % per 1 mol of alcohol for sodium hydroxide and potassium hydroxide. Since ethylene oxide reacts with water to produce ethylene glycol, it is very important to prevent moisture from entering the reaction system, and a dehydration treatment may be performed, if necessary, before the reaction in step (A).

Step (B) can be performed under the same conditions as step (A). Since propylene oxide has a boiling point of 34.2° C. and is a gas at a reaction temperature of 50° C. to 200° C., it is preferable to carry out the reaction in a pressurized environment in a sealed container. As the catalyst, the one used in step (A) may be used as is, or a catalyst may be newly added. Where a catalyst is newly added, the one used in step (A) is preferable.

Structural formula (3) is a polyetheramine (monoamine) having a structure in which ethylene oxide and propylene oxide are block-type addition polymerized. The amino group at the end of this polyetheramine interacts with the surface functional group of the carbon black, which is the conductive filler, through hydrogen bonding and acts as a dispersing agent for the carbon black. In addition, in order to enhance the effect thereof as a dispersing agent, R31, which is a monovalent hydrocarbon group having 1 to 8 carbon atoms, is introduced, resulting in a structure that is likely to have affinity with the hydrophobic functional group of the polycarbonate urethane and that also has good compatibility with the polycarbonate urethane.

Polyether monoamines can be commercially available products or can be obtained by synthesis. The synthesis of polyether monoamines can be performed by carrying out the following step (C) followed by step (D).
Step (C): Oxidation reaction of a compound of structural formula (2), which is a secondary alcohol.
Step (D): Reductive amination reaction of the product obtained in step (C).

Step (C) is a reaction to generate a ketone by oxidation of a secondary alcohol. The synthesis of a ketone by oxidation of a secondary alcohol can be performed by an oxidation reaction using heavy metal salts and derivatives thereof, such as chromic acid and manganese dioxide, or an oxidation reaction using non-heavy metal salts, such as dimethyl sulfoxide (DMSO) and hypohalous acids, such as hypochlorous acid.

Either method may be used for synthesis, but in consideration of the environmental impact of heavy metals, an oxidation reaction using dimethyl sulfoxide (DMSO) and hypohalous acids, such as hypochlorous acid, is preferred. Furthermore, dimethyl sulfoxide (DMSO) can react explosively at room temperature depending on the electrophilic activation reagent used, so a low temperature of −60° C. is required, making the method using hypohalous acids more preferable. Examples of hypohalous acids include hypochlorites such as sodium hypochlorite and calcium hypochlorite (bleaching powder). Ketones are obtained by reacting these hypochlorites with secondary alcohols in acetic acid.

When dimethyl sulfoxide (DMSO) is used, an electrophilic activating agent is also required. The electrophilic activating agent increases the electrophilicity of sulfur in DMSO, which is then subjected to nucleophilic attack by the alcohol hydroxyl group. This nucleophilic attack produces dimethylalkoxysulfonium salts, which then decompose to produce ketones and dimethyl sulfide. Examples of electrophilic activating agents include dicyclohexylcarbodiimide (DCC), acetic anhydride, phosphorus pentoxide, sulfur trisulfide-pyridine complex, trifluoroacetic anhydride, oxalyl chloride, and halogens.

Step (D) is a reductive amination reaction that converts a ketone to an amine. The reaction is divided into two stages. First, a carbonyl group reacts with an amine to generate an iminium cation. Next, a hydride reducing agent attacks the iminium cation with a nucleophilic attack to generate an amine. A borohydride reagent is preferably used as the reducing agent. Examples of borohydride reagents include sodium cyanoborohydride, sodium triacetoxyborohydride, and 2-picoline-borane. Among these, low-toxicity sodium triacetoxyborohydride and 2-picoline-borane are preferred. In the reductive amination reaction using a borohydride reagent, where the reagent has a bulky structure, steric hindrance makes it difficult to generate an iminium cation. For this reason, it is preferable that R31 in structural formula (3) be a monovalent hydrocarbon group having 1 to 8 carbon atoms.

Structural formula (4) is a polyoxyethylene alkyl ether acetic acid. The terminal carboxylic acid in structural formula (4) interacts with the surface functional group of carbon black, which is a conductive filler, through hydrogen bonding, and acts as a dispersing agent for the carbon black. In addition, in order to enhance the effect thereof as a dispersing agent, R41, which is a monovalent hydrocarbon group having 1 to 12 carbon atoms, is introduced, resulting in a structure that is likely to have affinity with the hydrophobic functional group of the polycarbonate urethane and that also has good compatibility with the polycarbonate urethane.

Polyoxyethylene alkyl ether acetic acids can be commercially available products or can be obtained by synthesis. The synthesis of polyoxyethylene alkyl ether acetic acids can be performed by carrying out step (F) after step (E) below. Step (F) may also be carried out on a commercially available product having a structure obtained by completing step (E).
Step (E): Reaction of alcohol with ethylene oxide.
Step (F): Oxidation reaction of the primary alcohol, which is the product of step (E).

Step (E) is the same as step (A), and the product thereof can be produced in the same manner as in step (A).

In step (F), a primary alcohol is oxidized to produce a carboxylic acid. Since the oxidation of primary alcohol produces an aldehyde and then subsequent oxidation produces a carboxylic acid, it is necessary to select a reaction method and conditions such that the reaction does not stop at aldehyde. A method for obtaining a carboxylic acid by oxidation of a primary alcohol can be exemplified by oxidation with an oxidizing agent and catalytic dehydrogenation reaction with a catalyst. Examples of oxidizing agents include permanganates, chromic acid, ruthenium tetroxide, and hypochlorites. Examples of catalysts for dehydrogenation reaction include palladium, platinum, iridium, rhodium, and manganese.

Compounds represented by structural formulas (2) to (4) function as dispersing agents for carbon black and have high affinity with polycarbonate urethane. Usually, surfactants are used to increase the dispersibility and dispersion stability of carbon black. However, compounds represented by structural formulas (2) to (4) have only a small number of functional groups that act on the surface functional groups of carbon black, and therefore exhibit a weak surfactant effect and are not generally used. Coupling agents and non-ionic surfactants are commonly used as dispersing agents for carbon black.

Silane coupling agents, titanate coupling agents, and aluminum coupling agents can be used as the coupling agent, while polyester surfactants and polyether surfactants can be used as the non-ionic surfactant. However, adding these dispersing agents to a level that sufficiently increases the dispersibility of carbon black in polycarbonate urethane (50% by mass to 100% by mass relative to carbon black) inhibits the conductivity of the carbon black and binder resin. Conversely, where the dispersing agents are added in an amount that does not inhibit the conductivity of carbon black and binder resin (10% by mass to 40% by mass relative to carbon black), dispersibility of carbon black cannot be obtained.

The addition amounts of the compounds represented by structural formulas (2) to (4) are preferably within the following ranges. The content of the compounds represented by structural formulas (2) to (4) in the resin layer is preferably 3.0% by mass to 7.0% by mass. Also, this content is preferably 18.9 parts by mass to 46.0 parts by mass per 100 parts by mass of carbon black.

Where the aforementioned addition amount is equal to or higher than the lower limit, the dispersibility of carbon black is improved, and the desired dispersibility is more easily achieved. Where the addition amount is equal to or lower than the upper limit, the urethane polymerization reaction is less likely to be inhibited, and the desired hardness and resistance are more easily obtained.

The presence of additives in the resin layer can be confirmed and quantitatively evaluated by the following method. The resin layer of the electrophotographic roller is cut out, and the slice is analyzed using, for example, ¹H-NMR, ¹³C-NMR, XPS, and FT-IR. This makes it possible to detect the carbonate structure of the binder resin, and the ether structure, amine structure, and carboxylic acid structure of the additives in the resin layer, and the ratio thereof can be calculated from the peak ratio etc.

Alternatively, the slice may be immersed overnight in an organic solvent such as methyl ethyl ketone for extraction, and the extract and the slice after extraction may be analyzed using ¹H-NMR, ¹³C-NMR, XPS, and FT-IR. The ratio of the additives incorporated and not incorporated during the resin polymerization reaction can thus be calculated.

The resin layer may have a structure in which at least one of the compounds having the structures shown in structural formulas (2) and (3) is bonded to polyurethane (a structure obtained by reaction during polyurethane polymerization). For example, the structure obtained by reaction during polyurethane polymerization may be in the following forms:
In the case of the structure shown by structural formula (2), a structure obtained by urethanization of the compound having the structure shown by structural formula (2) in the polyurethane.
In the case of the structure shown by structural formula (3), a structure obtained by urethanization of the compound having the structure shown by structural formula (3) in the polyurethane.

### Other Additives

In addition to those described above, the resin layer can contain various additives such as crosslinking agents, crosslinking aids, plasticizers, fillers, extenders, vulcanizing agents, vulcanization assistants, antioxidants, anti-aging agents, processing aids, dispersing agents, and leveling agents, as long as these additives do not impair the above-described functions.

### Manufacturing Methods

### Method for Manufacturing Resin Layer

A method for manufacturing the electrophotographic roller preferably includes a step of preparing a conductive substrate and a step of forming a resin layer on the outer peripheral surface side of the substrate. The step of forming the resin layer preferably includes a step of obtaining a crosslinked urethane resin by applying and curing a urethane raw material mixture (resin layer coating material) containing a urethane raw material and a surface modifier that form a crosslinked urethane resin. Furthermore, it is preferable to impregnate the crosslinked urethane resin with a (meth)acrylic monomer that forms a crosslinked acrylic resin, polymerize the (meth)acrylic monomer, and form a crosslinked acrylic resin to obtain a resin layer.

Before the step of forming the resin layer, a step of forming an elastic layer on the outer surface of the substrate may be performed. The elastic layer can be obtained, for example, by applying a silicone rubber mixture to the outer surface of the substrate and curing.

A method for forming the resin layer containing the crosslinked urethane resin is not particularly limited, but a coating molding method using a liquid coating material is preferable. For example, it is preferable to disperse and mix the materials for the resin layer in a solvent to form a urethane raw material mixture into a coating material, which is then coated on a conductive substrate and dried and solidified or cured by heating.

As the solvent, a polar solvent is preferable from the viewpoint of compatibility with polyols and isocyanate compounds, which are the raw materials for the crosslinked urethane resin.

Examples of polar solvents include alcohols such as methanol, ethanol, and n-propanol, ketones such as acetone, methyl ethyl ketone, and methyl isobutyl ketone, and esters such as methyl acetate and ethyl acetate. Among these, one or two or more solvents that are compatible with other materials can be used in combination.

The solid content when making the coating material can be freely adjusted by the amount of solvent mixed, but from the viewpoint of uniformly dispersing the electronic conductive material such as carbon black described hereinbelow, it is preferable that the solid content be from 20% by mass to 40% by mass. For dispersion and mixing, known dispersion devices using beads such as sand mills, coating material shakers, dyno mills, and pearl mills can be used. For coating, dip coating, ring coating, spray coating, or roll coating can be used.

For example, a polyol, an isocyanate compound, etc., which are the raw materials for the binder resin, carbon black, surface modifiers, additives, etc. are mixed to obtain a liquid coating material. The resin layer coating material is coated on the substrate. After that, the resin layer is dried and solidified or cured by heating to form a crosslinked urethane resin.

Next, the resin layer formed as described above is impregnated with liquid (meth)acrylic monomer. The liquid (meth)acrylic monomer can be impregnated as it is, or as an impregnation treatment liquid obtained by dilution, as appropriate, with various solvents. By appropriately diluting the liquid (meth)acrylic monomer with various solvents, a resin layer with a more uniform surface composition can be obtained.

The solvent can be freely selected as long as both the affinity with the resin layer and the ability to dissolve the (meth)acrylic monomer are satisfied. Examples include alcohols such as methanol, ethanol, and n-propanol, ketones such as acetone, methyl ethyl ketone, and methyl isobutyl ketone, and esters such as methyl acetate and ethyl acetate.

In addition, a polymerization initiator is mixed, as appropriate, into the impregnation treatment liquid. Details of the polymerization initiator are as described above. A method of impregnation with the impregnation treatment liquid is not particularly limited, and dip coating, ring coating, spray coating, or roll coating can be used. After that, the resin layer is dried, for example, at 80° C. to 120° C. for 0.5 h to 3 h to volatilize the solvent.

By such a process, the crosslinked (meth)acrylic resin is introduced into the mesh structure of the crosslinked urethane resin of the resin layer in a mutually intertwined form, and an IPN structure can be formed. In particular, it is preferable to form an IPN structure with a crosslinked polymer having a higher elastic modulus than the crosslinked urethane resin, particularly with a crosslinked (meth)acrylic resin.

This IPN structure is formed by impregnating the crosslinked urethane resin as the first component from the outer surface with a (meth)acrylic monomer and a polymerization initiator, and then forming a crosslinked acrylic resin as the polymer of the second component. In this case, the (meth)acrylic monomer penetrates between the three-dimensional mesh structure of the crosslinked urethane resin and polymerizes to form a crosslinked acrylic resin mesh structure.

The thickness of the resin layer is 2.0 μm to 30.0 μm, preferably 5.0 μm to 30.0 μm, and more preferably 10.0 μm to 20.0 μm.

### Process Cartridge and Electrophotographic Image Forming Apparatus

An electrophotographic image forming apparatus includes an electrophotographic roller.

The electrophotographic image forming apparatus of the present disclosure includes an image bearing member for bearing an electrostatic latent image, a charging roller for primarily charging the image bearing member, and a developing roller for developing the electrostatic latent image with toner to form a toner image.

The electrophotographic image forming apparatus may include an image bearing member for bearing an electrostatic latent image, a charging roller for primarily charging the image bearing member, an exposure device for forming an electrostatic latent image on the primarily charged image bearing member, a developing roller for developing the electrostatic latent image with toner to form a toner image, and a transfer device for transferring the toner image to a transfer material.

It is preferable that either one or both of the charging roller and the developing roller be the electrophotographic roller of the present disclosure.

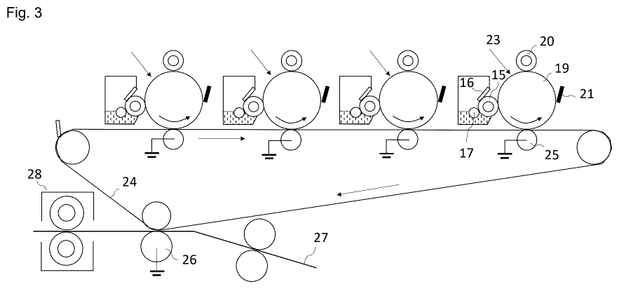

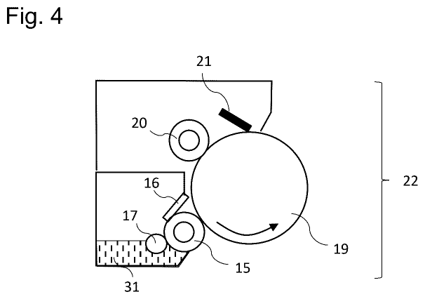

FIG. 3 is a cross-sectional view showing an outline of an electrophotographic image forming apparatus according to one embodiment of the present disclosure. FIG. 4 is an enlarged cross-sectional view of a process cartridge 22 to be mounted in the electrophotographic image forming apparatus of FIG. 3. This process cartridge 22 includes an image bearing member 19, a charging device including a charging roller 20, and a developing device including a developing roller 15. The process cartridge may have a cleaning device including a cleaning member 21. The process cartridge includes an electrophotographic roller. It is preferable that either or both of the charging roller and the developing roller be the electrophotographic roller of the present disclosure. The process cartridge is configured to be detachably attachable to the main body of the electrophotographic image forming apparatus of FIG. 3.

The image bearing member 19 is uniformly charged (primary charging) by the charging roller 20 connected to a bias power source (not shown). The charging potential of the image bearing member 19 at this time is from −800 V to −400 V. Next, the image bearing member 19 is irradiated by an exposure device (not shown) with exposure light 23 for writing an electrostatic latent image, and an electrostatic latent image is formed on the surface of the image bearing member. Either LED light or laser light can be used as the exposure light 23. The surface potential of the exposed portion of the image bearing member 19 is from −200 V to −100 V.

Next, the developing roller 15 applies a negatively charged toner 31 to the electrostatic latent image (development process), forming a toner image on the image bearing member 19 and converting the electrostatic latent image into a visible image. At this time, a voltage of from −500 V to −300 V is applied to the developing roller 15 by a bias power source (not shown). The developing roller 15 is in contact with the image bearing member 19 with a nip width of from 0.5 mm to 3 mm.

In the process cartridge according to one embodiment of the present disclosure, a toner supply roller 17 is in contact with the developing roller 15 in a rotatable state on the upstream side in the rotation direction of the developing roller 15 with respect to the contact portion between a developing blade 16, which is a toner layer thickness control member, and the developing roller 15. The toner image developed on the image bearing member 19 is primarily transferred to an intermediate transfer belt 24. A primary transfer member 25 is in contact with the back surface of the intermediate transfer belt 24, and a voltage of from +100 V to +1500 V is applied to the primary transfer member 25 to perform primary transfer of a negative toner image from the image bearing member 19 to the intermediate transfer belt 24. The primary transfer member 25 may be in the form of a roller or a blade.

When the electrophotographic image forming apparatus is a full-color image forming apparatus, the above-mentioned charging, exposure, development, and primary transfer steps are performed for each of the colors of yellow, cyan, magenta, and black. For this purpose, in the electrophotographic image forming apparatus shown in FIG. 3, a total of four process cartridges each containing toner of each color are detachably mounted on the main body of the electrophotographic image forming apparatus. The above-mentioned charging, exposure, development, and primary transfer steps are performed sequentially with a predetermined time difference, and a state in which four color toner images are superimposed on the intermediate transfer belt 24 to express a full-color image is created.

The toner image on the intermediate transfer belt 24 is transported to a position facing a secondary transfer member 26 as the intermediate transfer belt 24 rotates. Between the intermediate transfer belt 24 and the secondary transfer member 26, the recording paper is transported along a recording paper transport route 27 at a predetermined timing, and the toner image on the intermediate transfer belt 24 is transferred to the recording paper by applying a secondary transfer bias to the secondary transfer member 26. At this time, the bias voltage applied to the secondary transfer member 26 is from +1000 V to +4000 V.

The recording paper to which the toner image has been transferred by the secondary transfer member 26 is transported to a fixing device 28, where the toner image on the recording paper is melted and fixed on the recording paper, and the recording paper is then discharged outside the electrophotographic image forming apparatus, completing the printing operation. Any toner remaining on the image bearing member 19 without being transferred from the image bearing member 19 to the intermediate transfer belt 24 is scraped off by a cleaning member 21 for cleaning the surface of the image bearing member 19, and the surface of the image bearing member 19 is cleaned.

### Method for Measuring SPM Elastic Modulus

First, a region including a cross section in the thickness direction of the resin layer of the electrophotographic roller is cut out by cutting a thin piece using a diamond knife with a cryomicrotome (product name: EMFC6, manufactured by Leica Microsystems) while maintaining the temperature at −110° C. Furthermore, a sample of 100 μm square having a width of 100 μm in the depth direction is prepared from the thin piece.

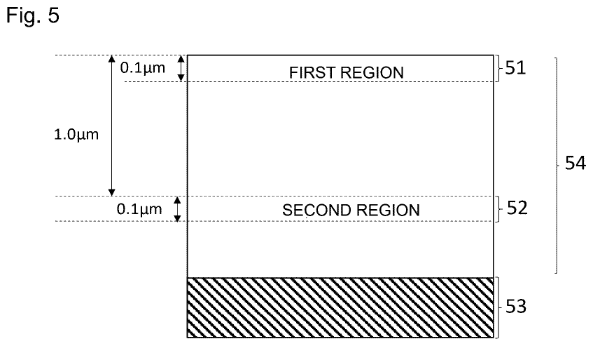

FIG. 5 shows a schematic cross-sectional view of a resin layer 54 formed on a conductive substrate 53. In this disclosure, as shown in FIG. 5, the region from the outer surface of the resin layer 54 to a depth of 0.1 μm is defined as a first region 51, and the region from the outer surface to a depth of 1.0 μm to 1.1 μm is defined as a second region 52.

The elastic modulus of the binder resin containing a crosslinked urethane resin as a binder is measured in each region that appears on the cross section of the prepared sample. For the measurement, an SPM device (product name: MFP-3D-Origin, manufactured by Oxford Instruments) and a probe (product name: AC160, manufactured by Olympus Corporation) are used. At this time, after first acquiring a shape image of 5 μm square, a force curve is measured 10 times at the position of the binder resin other than the roughness-forming particles and carbon black, and arithmetic mean of 8 points excluding the maximum and minimum values is obtained. The elastic modulus can be calculated by Hertz theory. The elastic moduli of the binder resin in the first region 51 and the second region 52 are defined as E1 and E2, respectively.

The meaning of E1 in the first region is as explained in the above-mentioned <Technical Significance of Requirement (1)>. E2 in the second region is the elastic modulus in the region from the outer surface to a depth of 1.0 μm to 1.1 μm. That is, the elastic modulus of the binder resin in the second region from the outer surface of the resin layer to a depth of 1.0 to 1.1 μm, which is measured in a cross section in the thickness direction of the resin layer, is taken as E2. In this case, the elastic modulus E2 is, for example, 120 MPa to 250 MPa, preferably 120 MPa to 200 MPa, and more preferably 140 MPa to 190 MPa.

When E2 in the second region is within the above-mentioned range, the load when the electrophotographic roller comes into contact with the toner is reduced, and filming occurring when the toner is physically crushed can be suppressed. In the present disclosure, it is more preferable to simultaneously satisfy E1, E2, and high dispersion of carbon black. By simultaneously satisfying the ranges of E1, E2, the arithmetic mean value Rc of the circle-equivalent diameter of carbon black, and the arithmetic mean value d of the distance between the wall surfaces, filming, scratches due to abrasion, and cracks due to the propagation of scratches can be simultaneously suppressed, and the durability of the electrophotographic roller can be significantly improved. Using an IPN structure is preferred as a method for increasing the elastic modulus E1, and E1 can be selectively increased without increasing E2. Therefore, the second region does not need to have an IPN structure.

As a method for increasing E1, for example, it is possible to increase significantly the crosslinking density of the rubber that constitutes the surface of the electrophotographic roller, but in such a case, the hardness is likely to increase even to the inside of the resin layer. By setting the elastic modulus E2 within the above range, scratches and filming can be more easily suppressed.

### Method for Confirming Interpenetrating Polymer Network (IPN) Structure

The IPN structure is verified by microsampling mass spectrometry. An ion trap type mass spectrometer is used for the microsampling mass spectrometry. A sample is fixed to the filament at the tip of a probe and inserted directly into an ionization chamber. The sample is then rapidly heated from room temperature to a temperature of 1000° C. at a constant heating rate. The sample decomposed and evaporated by heating is ionized by irradiation with an electron beam, followed by detection with a mass spectrometer.

At this time, under conditions of a constant heating rate, a thermal chromatogram similar to the TG-MS (thermogravimetric-mass simultaneous analysis) method is obtained, which has a mass spectrum called a total ion chromatogram (TIC). In addition, a thermal chromatogram for a fragment of a predetermined mass can also be obtained, so the peak temperature of the thermal chromatogram corresponding to the decomposition temperature of the desired molecular structure can be obtained. The peak temperature of the thermal chromatogram is correlated with the crosslinked structure in the resin structure, and the denser the crosslinking, the higher the peak temperature will be. In other words, the peak temperature of the thermal chromatogram will be higher in the part where the crosslinked urethane resin and the crosslinked (meth)acrylic resin form an IPN structure than in the crosslinked (meth)acrylic resin alone.

A peak top temperature A1 of the thermal chromatogram derived from the crosslinked acrylic resin is obtained from the first sample obtained from the first region, which is the region from the outer surface of the resin layer to a depth of 0.1 μm. Furthermore, a peak top temperature A2 of the thermal chromatogram derived from the crosslinked acrylic resin measured from the second sample obtained by decomposing the crosslinked urethane resin contained in the first sample is obtained. Where an IPN structure is formed, A1 will be higher than A2 in terms of the peak temperature of the thermal chromatogram.

A2 is a value obtained by performing microsampling mass spectrometry on the second sample obtained after decomposing the crosslinked urethane by the pyridine decomposition method described below.

### Pyridine Decomposition Method

The pyridine decomposition method is a method for selectively decomposing urethane bonds. By performing the pyridine decomposition method on a sample having an IPN structure of crosslinked acrylic resin and crosslinked urethane resin, it is possible to obtain the crosslinked acrylic resin after removing the structure derived from the crosslinked urethane. The presence or absence of an IPN structure can be confirmed by capturing the change in the peak temperature of the thermal chromatogram of this crosslinked acrylic resin. Specifically, the pyridine decomposition method is carried out as follows.

Using a microtome, a sample is cut out from the outer surface of the resin layer of the electrophotographic roller at a thickness of 0.1 μm, and 500 mg of the sample is collected. A total of 0.5 mL of a mixture of pyridine (manufactured by Wako Pure Chemical Industries, Ltd.) and water in a ratio of 3:1 is added to the obtained sample, and the sample is decomposed by heating at 130° C. for 15 h in a closed container made of fluororesin (“Teflon” (registered trademark)) and equipped with a stainless steel jacket. The pyridine is removed by the reduced pressure treatment of the decomposition product obtained. The sample thus obtained is used to implement the above-mentioned microsampling mass spectrometry method and obtain the value of A2.

### Calculation of Each Physical Property Such as Circle-Equivalent Diameter and Distance Between Wall Surfaces of Carbon Black Dispersed in Resin Layer

The circle-equivalent diameter and distance between the wall surfaces of carbon black dispersed in the resin layer were measured by the following methods.

First, a slice (thickness of 0.5 mm to 1.0 mm) is cut out using a razor so that a cross section perpendicular to the longitudinal direction of the electrophotographic roller can be observed. Where the adhesion between the substrate and the resin layer is high and it is difficult to cut out with a razor, the slice is cut out together with the substrate by using a hacksaw or the like, and then the cross section setting processing is performed with a FIB (Focused Ion Beam) device.

Then, platinum is vapor deposited onto the slice, and a scanning electron microscope (SEM) (product name: JSM-7800F, manufactured by JEOL Ltd.) is used to capture the image of the resin layer at a magnification of 15,000× to obtain a cross-sectional image.

Furthermore, in order to quantify the cross-sectional image obtained by observation with the SEM, image processing software (product name: Luzex AP, manufactured by Nireco Corporation) is used to convert the cross-sectional image into 8-bit grayscale, thereby obtaining a monochrome image with 256 gradations. Next, the white-and-black image is inverted so that the carbon black in the cross-sectional image becomes white, and then a binarization threshold is set for the brightness distribution of the image on the basis of the algorithm of Otsu's discriminant analysis method, thereby obtaining a binarized image in which the carbon black is white and the binder resin is black.

Then, image processing software (product name: Luzex AP, manufactured by Nireco Corporation) is used for the obtained binarized image to calculate the circle-equivalent diameter Rc of the whitened carbon black portion and the distance d between the adjacent wall surfaces. The image region for calculating the circle-equivalent diameter and the distance between the adjacent wall surfaces is set to within 0.075 μm as the actual image dimensions (when there is a text section describing the SEM measurement conditions etc., the image region is set within 0.075 μm from a portion where the actual image begins) in order to eliminate the uncertainty of the calculated values for the carbon black that is fragmented at the top, bottom, left, and right ends of the image, and the circle-equivalent diameter and the distance between the adjacent wall surfaces for the entire carbon black within the designated image region are calculated.

Then, the arithmetic mean value and standard deviation are calculated for the distribution of the obtained circle-equivalent diameter and the distance between the adjacent wall surfaces. The number of images used for image analysis is 12 points at 0°, 90°, 180°, and 270° in the circumferential direction, at positions ¼, ½, and ¾ of the length from the end, by dividing the roller into four equal parts in the longitudinal direction.

The number average diameter of the primary particles of carbon black dispersed in the resin was measured using a transmission electron microscope (TEM). First, a sliced sample was prepared. A known method can be used for slicing. For example, a sample can be sliced using an ion beam, a diamond knife, or the like. In the present disclosure, an ultramicrotome (product name: ULTRACUT-S, manufactured by Leica Microsystems) was used to prepare a 40 nm-thick sliced sample for observation.

A transmission electron microscope (product name: H-7100FA, manufactured by Hitachi High-Technologies Corporation) was then used to obtain a TEM image under measurement conditions of a TE mode and an acceleration voltage of 100 kV.

Image analysis software (product name: WinROOF, manufactured by Mitani Shoji Co., Ltd.) was used to measure the circle-equivalent diameter of 50 primary particles of carbon black in the obtained TEM image, and the number-average value of the 50 particles on the TEM image was taken as the number-average diameter of the primary particles.

### Measurement of DBP Absorption Amount of Carbon Black

The DBP absorption amount of carbon black was measured for carbon black powder according to Japanese Industrial Standards (JIS) K6217-4.

### Measurement of pH of Carbon Black

The pH of carbon black was measured for carbon black powder according to ASTM D1512.

### Measurement of Thickness of Resin Layer in Developing Roller

The thickness of the resin layer was measured by measuring the thickness of the resin part that does not contain fine particles using an optical microscope or an electron microscope on a cross section of the resin layer in the thickness direction. The measurement was conducted on three locations in the circumferential direction of the developing roller for each of three locations in the direction perpendicular to the circumferential direction (axial direction), for a total of nine locations. The arithmetic mean value of the thicknesses at each measurement location was taken as the thickness of the resin layer.

### EXAMPLES

The present disclosure will be described in more detail below using examples, but these are not intended to limit the present disclosure in any way.

### Example 1

### 1. Preparation of Conductive Substrate

A primer (product name: DY35-051, manufactured by Dow Corning Toray Co., Ltd.) was applied to a SUS304 core metal with an outer diameter of 6 mm and a length of 270 mm, and heated at a temperature of 150° C. for 20 min. This core metal was placed, as a substrate, concentrically in a cylindrical mold with an inner diameter of 12.0 mm.

As a material for the elastic layer that will become the intermediate layer, an addition-curable liquid silicone rubber mixture obtained by mixing the materials shown in Table 1 below with a kneader (product name: Trimix TX-15, manufactured by Inoue Mfg., Inc.) was injected into a mold heated to a temperature of 115° C. After the material was injected, it was heated and molded at a temperature of 120° C. for 10 min, cooled to room temperature, and then removed from the mold to obtain a conductive substrate (elastic roller 1) with a 3.0 mm thick elastic layer formed on the outer periphery of the substrate.

TABLE 1

| | Parts |
|---|---|
| Materials | by mass |
| Liquid dimethylpolysiloxane having 2 or more silicon | 100 |
| atom-bonded alkenyl groups in a molecule (product name: | |
| SF3000E, viscosity 10,000 cP, vinyl equivalent 0.05 mmol/g, | |
| manufactured by KCC Corp.) | |
| Platinum-based catalyst (product name: SIP6832.2, | 0.048 |
| manufactured by Gelest, Inc.) | |
| Dimethylpolysiloxane having 2 or more silicon atom-bonded | 0.5 |
| hydrogen atoms in a molecule (product name: SP6000P, Si-H | |
| equivalent 15.5 mmol/g, manufactured by KCC Corp.) | |
| Carbon black (product name: Toka Black #7360SB, | 6.0 |
| manufactured by Tokai Carbon Co., Ltd.) | |

### 2. Formation of Resin Layer

As the materials for the resin layer, the polyol, isocyanate, and additives (materials other than carbon black and roughness-forming particles) shown in Table 2 below were stirred and mixed with a disperser. Next, carbon black shown in Table 2 below was added little by little while stirring and mixing with the disperser, and after the addition was completed, stirring and mixing were carried out for 30 min. Then, the mixture was dissolved in methyl ethyl ketone so that the solid concentration was 30% by mass, and after further premixing for 1 h, the mixture was dispersed for 4 h with a sand mill using glass beads with a particle diameter of 1.5 mm. Furthermore, roughness-forming particles were added and dispersed for additional 10 min with the sand mill to obtain a resin layer coating material 1.

The elastic roller 1 was immersed in this coating material and coated so that the resin layer was applied to a thickness of 15 μm. Then, the roller was heated at a temperature of 135° C. for 60 min to dry and cure the coating film to form a crosslinked urethane resin in the resin layer.

TABLE 2

| | Parts |
|---|---|
| Materials | by mass |
| Polycarbonate polyol (product name: Kuraray Polyol C2090, | 100 |
| manufactured by Kuraray Co., Ltd.) | |
| Polymeric MDI (product name: MR-400, manufactured by | 37.2 |
| Tosoh Corporation) | |
| Carbon black (product name: MA8, manufactured by Mitsubishi | 35.0 |
| Chemical Corp.) | |
| Polyoxyethylene polyoxypropylene butyl ether (product name: | 7.0 |
| Unilube 50MB-26, manufactured by NOF Corp.) | |
| Roughness-forming particles (product name: Art Pearl C400-T, | 23 |
| manufactured by Negami Chemical Industrial Co., Ltd.) | |
| Modified silicone oil (product name: TSF4445, manufactured by | 0.6 |
| Momentive Performance Materials Japan Co., Ltd.) | |

Then, the impregnation and curing treatment of a (meth)acrylic monomer capable of forming a crosslinked acrylic resin was carried out by the following method. The materials shown in Table 3 below were dissolved and mixed as materials for the impregnation liquid for the impregnation treatment. The elastic roller on which the crosslinked urethane resin was formed was immersed in this impregnation liquid for 2 sec to perform the impregnation treatment and impregnate the (meth)acrylic monomer component. After that, the roller was immediately dried at 90° C. for 1 h to volatilize the solvent.

The dried elastic roller was rotated and irradiated with ultraviolet light so that the accumulated light quantity was 15,000 mJ/cm², thereby curing the (meth)acrylic monomer, forming an IPN structure and obtaining a resin layer. A high-pressure mercury lamp (product name: Handy Type UV Curing Device, manufactured by Mario Network Co., Ltd.) was used as the ultraviolet irradiation device.

TABLE 3

| | Parts |
|---|---|
| Materials | by mass |
| Acrylic monomer (product name: EBECRYL 145, | 5.0 |
| manufactured by Daicel-Allnex Corporation) | |
| Photopolymerization initiator (product name: Omnirad 184, | 0.25 |
| manufactured by IGM Resins Co., Ltd.) | |
| Solvent | 100 |
| Methyl ethyl ketone | |

The following evaluations were carried out on the obtained electrophotographic rollers.

### Evaluation Method

### Calculation of Circle-Equivalent Diameter and Distance Between Wall Surfaces of Carbon Black Dispersed in Resin Layer

By using the above-described method for calculating the circle-equivalent diameter and the distance between the wall surfaces of carbon black dispersed in the resin layer described, σc/Rc and σc/d were calculated, where Rc is the circle-equivalent diameter, d is the distance between the wall surfaces of carbon black, σc [nm] is the standard deviation of the circle-equivalent diameter, and σc [nm] is the standard deviation of the distance between the wall surfaces. The results are shown in Table 9.

### Measurement of SPM Elastic Moduli

The elastic moduli E1 and E2 of the first and second regions were calculated using the above-described method for measuring an SPM elastic modulus described above. The results are shown in Table 9.

### Durability Evaluation

The electrophotographic roller was mounted as a developing roller on a process cartridge for a color laser printer (product name: HP Color LaserJet Enterprise M652dn, manufactured by Hewlett-Packard Co.), and the process cartridge was mounted on the color laser printer to evaluate the state of scratches due by abrasion on the surface of the electrophotographic roller. For the evaluation, a process cartridge for the color laser printer (cyan, product name: HP 656X High Yield Cyan Original LaserJet Toner Cartridge, manufactured by Hewlett-Packard Co.) was used. The evaluation procedure is as follows.

The process cartridge was allowed to stand for 16 h in a high-temperature and high-humidity environment with a temperature of 30° C. and a relative humidity of 95%, and then a low-print image with a print percentage of 0.2% was continuously output on recording paper to perform the evaluation in the same environment with a very large number of sheets printed. However, since toner is consumed by printing, toner was replenished so that the toner weight in the process cartridge was 100 g every time 50,000 sheets were output.

After printing 200,000 sheets, the developing roller was removed from the process cartridge, the roller surface was air-blown to remove the toner on the surface, and the roller surface condition was visually observed and evaluated according to the following criteria. The evaluation results are shown in Table 9.

### Evaluation Criteria

Rank “A”: No scratches due to abrasion can be confirmed on the surface.
Rank “B”: Scratches can be confirmed, but the largest scratch is less than 1 mm in length.
Rank “C”: The occurrence of scratches of 1 mm or more can be confirmed.

### Evaluation of Crack Resistance

The electrophotographic roller after the durability printing was aged for 24 h or more in a low-temperature environment of 10° C. and 15% relative humidity, and the surface roughness Ra was measured using the method described below. Next, under the same environment, a brush made of SUS304 (product name: SUS304 stainless steel brush, manufactured by Taiyo Shokai Co., Ltd.) was placed vertically against the electrophotographic roller, the roller was rubbed 10 times while applying a load of 10 N, and then the roller was allowed to stand for 1 h. After that, under the same environment, the surface roughness Ra was measured again, and the difference ΔRa in the surface roughness Ra before and after the evaluation was evaluated according to the following criteria. The evaluation results are shown in Table 9.

### Evaluation Criteria

Rank “A”: ΔRa before and after evaluation is 0.20 μm or less.
Rank “B”: ΔRa before and after evaluation is more than 0.20 μm and less than or equal to 0.40 μm.
Rank “C”: ΔRa before and after evaluation is more than 0.40 μm.

### Method for Measuring Surface Roughness (Ra)

The surface roughness Ra (JIS B0601) of the electrophotographic roller was measured using a surface roughness meter (product name: Surfcom 480A, manufactured by Tokyo Seimitsu Co., Ltd.) and the value of Ra was recorded. The measurement conditions were a 2 μm radius stylus, pressing pressure of 0.7 mN, measurement speed of 0.3 mm/sec, measurement magnification of 5000 times, cutoff wavelength of 0.8 mm, and measurement length of 2.5 mm. The arithmetic mean value for nine points at 0°, 120°, and 240° in the circumferential direction at each of positions ¼, ½, and ¾ of the length from the end was used.

### Examples 2, 4-11, and 13-15 and Comparative Examples 1, 4, and 6

The coating materials for the respective resin layers were prepared from the materials shown in Table 7 by the same method as was used in Example 1, the impregnation treatment liquids were prepared from the materials shown in Table 8, and the respective electrophotographic rollers were produced using the combinations shown in Table 9. The electrophotographic rollers obtained were evaluated by the same methods as in Example 1. The evaluation results are shown in Table 9.

### Example 3

### Synthesis of Polyoxyethylene Octyl Ether Acetic Acid: Additive A

A total of 169.3 g of 1-octanol (manufactured by Tokyo Chemical Industry Co., Ltd.) and 3.0 g of potassium hydroxide were placed in an autoclave equipped with a stirring device, a temperature control device, and an automatic feeder, and dehydration was performed for 30 min at 110° C. and 1.2 kPa. After completion of dehydration, the mixture was purged with nitrogen, the temperature was raised to 150° C., and then 858.0 g of ethylene oxide (15 mol relative to alcohol) was charged. The reaction was carried out at 150° C. for 1 h, and an ethylene oxide adduct with an average number of moles added of 15 moles was obtained.

A total of 77.4 g of the obtained ethylene oxide adduct was mixed with 510 mL of 1 mol/L aqueous sodium hydroxide solution, and 71.1 g of potassium permanganate was added and stirred at room temperature for 6 h. Then, 760 mL of 2-propanol was added and stirred for 1 h to quench the excess potassium permanganate, and the by-product manganese oxide was filtered out. The aqueous layer was extracted with dichloromethane and purified to obtain additive A, which is polyoxyethylene octyl ether acetic acid. The structure of R41 and the value of x of additive A are shown in Table 5.

A resin layer coating material was prepared from the materials shown in Table 7, and an impregnation treatment liquid was prepared from the materials shown in Table 8, by the same methods as in Example 1, except that additive A was used in the resin layer coating material, and an electrophotographic roller of Example 3 was produced using the combination shown in Table 9. The obtained electrophotographic roller was evaluated by the same method as in Example 1. The evaluation results are shown in Table 9.

### Example 12

### Synthesis of Polyetheramine: Additive B

A stirrer was attached to a three-neck flask, and 1658 g of polyoxyethylene polyoxypropylene octyl ether and 460 mL of acetic acid were added. A total of 600 mL of 2 mol/L aqueous sodium hypochlorite solution was added dropwise over 1 h. The reaction vessel was placed in an ice bath to cool, and the temperature was adjusted to within the range of 15° C. to 25° C. After the dropwise addition was completed, stirring was continued for 1 h. Dichloromethane was added to the resulting liquid, and the aqueous layer was extracted, post-treated, and purified using a column to obtain a compound in which secondary alcohol was ketonized.

Cooling to 0° C. was performed in an ice bath, 250 mL of a methanol-acetic acid mixed solution (volume ratio 10:1) was added to 41.4 g of the resulting compound in which secondary alcohol was ketonized, and 2.7 g of 2-picoline-borane was added. The ice bath was removed, and the mixture was stirred overnight in an open system at room temperature. After concentration, the mixture was cooled to 0° C., 360 mL of 35% aqueous hydrochloric acid solution was added, and the mixture was stirred at room temperature for 2 h. An aqueous sodium hydroxide solution was added to make the mixture basic, and the aqueous layer was extracted with dichloromethane, post-treated, and purified using a column to obtain additive B, which is a polyetheramine. The structure of R31 and the values of v and w of additive B are shown in Table 5.

A resin layer coating material was prepared from the materials shown in Table 7 by the same method as in Example 1, except that additive B was used in the resin layer coating material, and an electrophotographic roller of Example 12 was produced using the combination shown in Table 9. The obtained electrophotographic roller was evaluated by the same method as in Example 1. The evaluation results are shown in Table 9.

### Example 16: Charging Roller

### Preparation of Conductive Substrate

A primer (product name: Metaloc N-33, manufactured by Toyo Kagaku Kenkyusho Co., Ltd.) was applied to a SUS304 core metal with an outer diameter of 6 mm and a length of 252 mm, and then heated at a temperature of 80° C. for 30 min, and then further heated at 120° C. for 1 h. As the material for the intermediate layer, the materials shown in component 1 in Table 4 below were mixed in a pressure kneader to obtain kneaded rubber composition A. Furthermore, the materials shown in the component 2 column in Table 4 were mixed with this kneaded rubber composition A in an open roll to prepare an unvulcanized rubber composition.

Next, a die with an inner diameter of 16.5 mm was attached to a crosshead extruder having a substrate supply mechanism and an unvulcanized rubber roller discharge mechanism, the extruder and die (crosshead) were adjusted to 80° C., and the conveying speed of the conductive substrate was adjusted to 60 mm/sec. Under these conditions, the unvulcanized rubber composition was fed from the extruder, and the unvulcanized rubber composition was coated as an elastic layer on the outer periphery of the conductive substrate in the crosshead. Next, this was placed in a hot air vulcanizing furnace at 170° C. and heated for 60 min. After cooling, the ends of the elastic layer were cut and removed, and the surface of the elastic layer was ground with a rotary grindstone to produce a conductive substrate (elastic roller 2) with a diameter of 8.4 mm at each position 90 mm from the center in the axial direction to both ends and a central diameter of 8.5 mm.

TABLE 4

| | | Parts |
|---|---|---|
| | Materials | by mass |
| Compo- | NBR rubber (product name: Nipol DN219, | 100 |
| nent 1 | manufactured by Nippon Zeon Co., Ltd.) | |
| | Carbon black (product name: Toka Black #4300, | 40 |
| | manufactured by Tokai Carbon Co., Ltd.) | |
| | Calcium carbonate (product name: Nanox #30, | 20.0 |
| | manufactured by Maruo Calcium Co., Ltd.) | |
| | Stearic acid (product name: Stearic Acid S, | 1.0 |
| | manufactured by Kao Corp.) | |
| Compo- | Sulfur (product name: Sulfax 2005, manufactured | 1.2 |
| nent 2 | by Tsurumi Chemical Industry Co., Ltd.) | |
| | Tetrabenzylthiuram disulfide (product name: TBZTD, | 4.5 |
| | manufactured by Sanshin Chemical Industry Co., Ltd.) | |

A resin layer coating material was prepared of the materials shown in Table 7 by the same method as in Example 1, except that the elastic roller 2 was used as the substrate, an impregnation treatment liquid was prepared of the materials shown in Table 8, and an electrophotographic roller of Example 16 was produced using the combination shown in Table 9.

The obtained electrophotographic roller was mounted as a charging roller on a process cartridge for a color laser printer (product name: HP Color LaserJet Enterprise M652dn, manufactured by Hewlett-Packard Co.), and the process cartridge was mounted on the color laser printer to evaluate the state of scratches due to abrasion on the surface of the electrophotographic roller. For the evaluation, a process cartridge for the color laser printer (cyan, product name: HP 656X High Yield Cyan Original LaserJet Toner Cartridge, manufactured by Hewlett-Packard Co.) was used. The evaluation procedure is as follows.

The process cartridge was allowed to stand for 16 h in a high-temperature and high-humidity environment with a temperature of 30° C. and a relative humidity of 95%, and then a low-print image with a print percentage of 0.2% was continuously output on recording paper to perform the evaluation in the same environment with a very large number of sheets printed. However, since the toner is consumed by printing, the toner was replenished so that the toner weight in the process cartridge was 100 g every time 50,000 sheets were output. After printing 200,000 sheets, the charging roller was removed from the process cartridge, the roller surface was air-blown to remove the toner on the surface, and the evaluation was performed by the same method as in Example 1. The evaluation results are shown in Table 9.

### Comparative Example 2

### Synthesis of Polyetheramine: Additive C

Additive C, which is a polyetheramine, was obtained by synthesizing polyoxyethylene polyoxypropylene decyl ether, and then ketonizing by secondary alcohol oxidation, followed by reductive amination.

### Synthesis of Polyoxyethylene Polyoxypropylene Decyl Ether

A total of 205.8 g of 1-decanol (manufactured by Tokyo Chemical Industry Co., Ltd.) and 3.0 g of potassium hydroxide were placed in an autoclave equipped with a stirring device, a temperature control device, and an automatic feeder, and dehydration was performed for 30 min at 110° C. and 1.2 kPa. After completion of dehydration, the mixture was purged with nitrogen, the temperature was raised to 150° C., and then 858.0 g of ethylene oxide (15 mol relative to alcohol) was charged. The reaction was carried out at 150° C. for 1 h, and an ethylene oxide adduct with an average number of moles added of 15 moles was obtained.

The resulting ethylene oxide adduct was cooled to 130° C., and 1132.6 g of propylene oxide (15 mol relative to alcohol) was charged. After the charging was completed, the reaction was carried out at 130° C. for 5 h, yielding a polyoxyethylene polyoxypropylene decyl ether adduct which is a block polymer with an average number of moles added of 15 mol of ethylene oxide and 15 mol of propylene oxide.

The resulting polyoxyethylene polyoxypropylene decyl adduct was cooled to 80° C., and unreacted ethylene oxide and propylene oxide were removed at 2.5 kPa for 30 min. Next, 6.0 g of 90% lactic acid was added to the autoclave, and after stirring at 80° C. for 30 min, extraction was performed to obtain polyoxyethylene polyoxypropylene decyl ether.

### Synthesis of Polyetheramine: Additive C

A stirrer was attached to a three-neck flask, and 1688 g of polyoxyethylene polyoxypropylene decyl ether and 460 mL of acetic acid were added. A total of 600 mL of a 2 mol/L aqueous sodium hypochlorite solution was added dropwise over 1 hour. The reaction vessel was placed in an ice bath to cool the mixture so that the temperature was within the range of 15° C. to 25° C. After the dropwise addition was completed, stirring was continued for 1 h. Dichloromethane was added to the resulting liquid, and the aqueous layer was extracted, post-treated, and purified using a column to obtain a compound in which secondary alcohol was ketonized.

Cooling to 0° C. was performed in an ice bath, 250 mL of a methanol-acetic acid mixed solution (volume ratio 10:1) was added to 41.4 g of the resulting compound in which secondary alcohol was ketonized, and 2.7 g of 2-picoline-borane was added. The ice bath was removed, and the mixture was stirred overnight in an open system at room temperature. After concentration, the mixture was cooled to 0° C., 360 mL of a 35% aqueous hydrochloric acid solution was added, and the mixture was stirred at room temperature for 2 h. An aqueous sodium hydroxide solution was added to make the mixture basic, and the aqueous layer was extracted with dichloromethane, post-treated, and purified in a column to obtain additive C, which is a polyetheramine. The structure of R31 and the values of v and w of additive C are shown in Table 5.

A resin layer coating material was prepared from the materials shown in Table 7, by the same method as in Example 1, except that additive C was used in the resin layer coating material, an impregnation treatment liquid was prepared from the materials shown in Table 8, and an electrophotographic roller of Comparative Example 2 was produced using the combination shown in Table 9. The obtained electrophotographic roller was evaluated by the same method as in Example 1. The evaluation results are shown in Table 9.

### Comparative Example 3

### Synthesis of Polyoxyethylene Hexadecyl Ether Acetic Acid: Additive D

A total of 315.2 g of 1-hexadecanol (Tokyo Chemical Industry Co., Ltd.) and 3.0 g of potassium hydroxide were placed in an autoclave equipped with a stirring device, a temperature controller, and an automatic feeder, and dehydration was performed for 30 min at 110° C. and 1.2 kPa. After completion of dehydration, the mixture was purged with nitrogen, the temperature was raised to 150° C., and 858.0 g of ethylene oxide (15 mol relative to alcohol) was then charged. The reaction was carried out at 150° C. for 1 h, and an ethylene oxide adduct with an average number of moles added of 15 mol was obtained.

A total of 90.2 g of the obtained ethylene oxide adduct was mixed with 510 mL of 1 mol/L aqueous sodium hydroxide solution, and 71.1 g of potassium permanganate was added and stirred at room temperature for 6 h. Then, 760 mL of 2-propanol was added and stirred for 1 h to quench excess potassium permanganate, and the by-product manganese oxide was filtered out. The aqueous layer was extracted with dichloromethane and purified to obtain additive D, which is polyoxyethylene hexadecyl ether acetic acid. The structure of R41 and the value of x of additive D are shown in Table 5.

A resin layer coating material was prepared from the materials shown in Table 7, by the same method as in Example 1, except that additive D was used in the resin layer coating material, an impregnation treatment liquid was prepared from the materials shown in Table 8, and an electrophotographic roller of Comparative Example 3 was produced using the combination shown in Table 9. The obtained electrophotographic roller was evaluated by the same method as in Example 1. The evaluation results are shown in Table 9.

TABLE 5

| Type | Materials | Structure | | |
|---|---|---|---|---|
| Addi- | Polyoxyethylene octyl | Structural | R41 = | x = |
| tive A | ether acetic acid | formula (4) | C₈H₁₇ | 14 |
| Addi- | Polyetheramine | Structural | R31 = | v, w = |
| tive B | | formula (3) | C₈H₁₇ | 15 |
| Addi- | Polyetheramine | Structural | R31 = | v, w = |
| tive C | | formula (3) | C₁₀H₂₁ | 15 |
| Addi- | Polyoxyethylene | Structural | R41 = | x = |
| tive D | hexadecyl ether | formula (4) | C₁₆H₃₃ | 14 |
| | acetic acid | | | |

### Comparative Example 5

With reference to the examples in Japanese Patent Laid-Open No. 2003-113347, the materials shown in Table 6 were used and stirred with zirconia beads for 1 h using a paint shaker to obtain a resin layer coating material 20.

An electrophotographic roller of Comparative Example 5 was produced by the same method as in Example 1, except that the resin layer coating material 20 was used for the resin layer. The electrophotographic roller obtained was evaluated by the same method as in Example 1. The evaluation results are shown in Table 9.

TABLE 6

| | | Parts |
|---|---|---|
| Type | Material name | by mass |
| Thermoplastic urethane resin | ME823LP | 100 |
| Silane coupling agent | A-187 | 15.7 |
| Polymer-based dispersing agent | Disperbyk-185 | 28.0 |
| Carbon black | MA77 | 40.0 |
| Surface modifying agent | FF-101 (D) | 1.5 |
| Leveling agent | GS-30 | 0.05 |
| Solvent | Methyl ethyl ketone | 240.0 |
| | N,N-dimethylformamide | 134.0 |
| Roughness-forming particles | C400-T | 23.0 |

*The materials listed in the table are as follows.
ME823LP: (manufactured by Dainichiseika Color & Chemicals Mfg. Co., Ltd.)
A-187: (manufactured by Momentive Co., Ltd.)
Disperbyk-185: (manufactured by BYK Co., Ltd.)
MA77: (manufactured by Mitsubishi Chemical Corporation)
FF-101(D): (manufactured by Dainichiseika Color & Chemicals Mfg. Co., Ltd.)
GS-30: (manufactured by Toa Gosei Co., Ltd.)
C400T: Art Pearl C400T crosslinked urethane resin particles (manufactured by Negami Chemical Industrial Co., Ltd., average particle diameter 15 μm)

TABLE 7

| | Material | Resin layer coating material No. | | | | | | | | | |
|---|---|---|---|---|---|---|---|---|---|---|---|
| Type | name | 1 | 2 | 3 | 4 | 5 | 6 | 7 | 8 | 9 | 10 |
| Polyol | C2090 | 100 | 100 | 100 | — | 100 | 100 | 100 | 100 | — | — |
| | C3090 | — | — | — | 100 | — | — | — | — | — | — |
| | PTMG1000 | — | — | — | — | — | — | — | — | 100 | — |
| | PTMG650 | — | — | — | — | — | — | — | — | — | 100 |
| | PTGL1000 | — | — | — | — | — | — | — | — | — | — |
| Isocyanate | MR-400 | 37.2 | 37.2 | 37.2 | 15.0 | 37.2 | 37.2 | 37.2 | 37.2 | 37.2 | 60.8 |
| Additive | 50MB-26 | 7.0 | — | — | 7.0 | 5.1 | 8.8 | 7.0 | 7.0 | 7.0 | 7.0 |
| | M-2005 | — | 7.0 | — | — | — | — | — | — | — | — |
| | Additive A | — | — | 7.0 | — | — | — | — | — | — | — |
| | A-13PR | — | — | — | — | — | — | — | — | — | — |
| | Additive B | — | — | — | — | — | — | — | — | — | — |
| | ECA-490 | — | — | — | — | — | — | — | — | — | — |
| | 20P-8 | — | — | — | — | — | — | — | — | — | — |
| | Additive C | — | — | — | — | — | — | — | — | — | — |
| | Additive D | — | — | — | — | — | — | — | — | — | — |
| | 50HB-100 | — | — | — | — | — | — | — | — | — | — |
| Modified | TSF4445 | 0.6 | 0.6 | 0.6 | 0.6 | 0.6 | 0.6 | 0.6 | 0.6 | — | — |
| silicone oil | | | | | | | | | | | |
| Carbon black | MA8 | 35.0 | 35.0 | 35.0 | 35.0 | — | — | — | — | — | — |
| | X55 | — | — | — | — | 35.0 | — | — | — | — | — |
| | MA11 | — | — | — | — | — | 40.0 | 23.0 | — | — | — |
| | X15 | — | — | — | — | — | — | — | 35.0 | 35.0 | 45.0 |
| Roughness- | C-400T | 23.0 | 23.0 | 23.0 | 23.0 | 23.0 | 23.0 | 23.0 | 23.0 | 23.0 | 23.0 |
| forming | UCN-5090 | — | — | — | — | — | — | — | — | — | — |
| particles | | | | | | | | | | | |
| | Material | Resin layer coating material No. | | | | | | | | | |
| Type | name | 11 | 12 | 13 | 14 | 15 | 16 | 17 | 18 | 19 | 21 |
| Polyol | C2090 | — | — | — | — | — | 100 | 100 | 100 | 100 | — |
| | C3090 | — | — | — | — | — | — | — | — | — | — |
| | PTMG1000 | — | — | — | — | — | — | — | — | — | — |
| | PTMG650 | 100 | 100 | 100 | 100 | 100 | — | — | — | — | — |
| | PTGL1000 | — | — | — | — | — | — | — | — | — | 100 |
| Isocyanate | MR-400 | 60.8 | 60.8 | 60.8 | 60.8 | 60.8 | 37.2 | 37.2 | 37.2 | 37.2 | 36.0 |
| Additive | 50MB-26 | — | — | — | — | — | — | — | — | — | — |
| | M-2005 | — | — | — | — | — | — | — | — | — | — |
| | Additive A | — | — | — | — | — | — | — | — | — | — |
| | A-13PR | 7.0 | — | — | 7.0 | 7.0 | — | — | — | — | — |
| | Additive B | — | 7.0 | — | — | — | — | — | — | — | — |
| | ECA-490 | — | — | 7.0 | — | — | — | — | — | — | — |
| | 20P-8 | — | — | — | — | — | 7.0 | — | — | — | — |
| | Additive C | — | — | — | — | — | — | 7.0 | — | — | — |
| | Additive D | — | — | — | — | — | — | — | 7.0 | — | — |
| | 50HB-100 | — | — | — | — | — | — | — | — | — | 3.0 |
| Modified | TSF4445 | — | — | — | — | 0.6 | 0.6 | 0.6 | 0.6 | 0.6 | 0.6 |
| silicone oil | | | | | | | | | | | |
| Carbon black | MA8 | — | — | — | 60.9 | 35.0 | 35.0 | 35.0 | 35.0 | 35.0 | — |
| | X55 | — | — | — | — | — | — | — | — | — | — |
| | MA11 | — | — | — | — | — | — | — | — | — | — |
| | X15 | 45.0 | 45.0 | 45.0 | — | — | — | — | — | — | 29.3 |
| Roughness- | C-400T | 23.0 | 23.0 | 23.0 | 23.0 | 23.0 | 23.0 | 23.0 | 23.0 | 23.0 | — |
| forming | UCN-5090 | — | — | — | — | — | — | — | — | — | 17.6 |
| particles | | | | | | | | | | | |

*The numbers in the table indicate the amount of each material in parts by mass.
*The materials listed in the table are as follows.
Polyols
Kuraray Polyol C2090: Polycarbonate polyol (manufactured by Kuraray Co., Ltd., molecular weight 2000)
Kuraray Polyol C3090: Polycarbonate polyol (manufactured by Kuraray Co., Ltd., molecular weight 3000)
PTMG1000: Polytetramethylene glycol (manufactured by Hodogaya Chemical Co., Ltd., molecular weight 1000)
PTMG650: Polytetramethylene glycol (manufactured by Hodogaya Chemical Co., Ltd., molecular weight 650)
PTGL1000: Polyether polyol (manufactured by Hodogaya Chemical Co., Ltd.)
Isocyanate
Millionate MR-400: Isocyanate compound, Polymeric MD I (manufactured by Tosoh Corporation)
Additives
Unilube 50MB-26: Polyoxyethylene polyoxypropylene butyl ether (manufactured by NOF Corporation)
JEFFAMINE M-2005: Polyetheramine (manufactured by Huntsman Co.)
Nonion A-13PR: Polyoxyethylene polyoxypropylene lauryl ether (manufactured by NOF Corporation)
Typol Soft ECA-490: Polyoxyethylene lauryl ether acetate (manufactured by Taiko Oil Chem. Co., Ltd.)
Unisafe 20P-8: Polyoxyethylene polyoxypropylene cetyl ether (manufactured by NOF Corporation)
Newpol 50HB-100: (Poly(oxyethyleneoxypropylene) glycol monobutyl ether (manufactured by Sanyo Chemical Industries, Ltd.))
Modified Silicone Oil
TSF4445: Modified silicone compound (manufactured by Momentive Performance Materials Japan, Inc.)
Carbon Black
MA8: Carbon black (manufactured by Mitsubishi Chemical Corporation, number-average diameter of primary particles: 24 nm, DBP oil absorption: 51 mL/100 g, pH: 3.0)
SUNBLACK X55 (manufactured by Asahi Carbon Co., Ltd., number-average diameter of primary particles: 25 nm, DBP oil absorption: 77 mL/100 g, pH: 3.0)
MA11: Carbon black (manufactured by Mitsubishi Chemical Corporation, number-average diameter of primary particles: 29 nm, DBP oil absorption: 64 mL/100 g, pH: 3.5)
SUNBLACK X15: (manufactured by Asahi Carbon Co., Ltd., number-average diameter of primary particles: 20 nm, DBP oil absorption: 96 mL/100 g, pH: 3.5)
Roughness-Forming Particles
Art Pearl C400T: Crosslinked urethane resin particles (manufactured by Negami Chemical Industries Co., Ltd., average particle diameter 15 μm)
Daimic Beads UCN-5090: Crosslinked urethane resin particles (manufactured by Dainichiseika Chemicals Co., Ltd., average particle diameter 9 μm)

TABLE 8

| | | Impregnation treatment | | |
|---|---|---|---|---|
| | | liquid No. | | |
| Type | Material name | 1 | 2 | 3 |
| Acryl monomer | EBECRYL145 | 5.0 | — | 3.0 |
| | TMPTA | — | 1.0 | — |
| Photopolymerization | Omnirad184 | 0.25 | 0.25 | 0.25 |
| initiator | | | | |
| Solvent | Methyl ethyl ketone | 100 | 100 | 100 |

*The numbers in the table indicate the amount of each material in parts by mass.
*The materials listed in the table are as follows.
EBECRYL145: Bifunctional acrylic monomer (manufactured by Daicel-Allnex Corporation)
TMPTA: Trifunctional acrylic monomer (manufactured by Daicel-Allnex Corporation)
Omnirad 184: Photopolymerization initiator (manufactured by IGM Resins Co., Ltd.)

TABLE 9

| | | | | | | | | | | Resistance to scratching | | | |
|---|---|---|---|---|---|---|---|---|---|---|---|---|---|
| | | | | | | | | | | After | After evaluation | | |
| | | Impregnation | | | | | | | | durabil- | of resistance to | | |
| | Resin coating | treatment | Rc | d | | | E1 | E2 | | ity Ra | scratching Ra | ΔRa | Evalu- |
| Name | material No. | liquid No. | (nm) | (nm) | σc/Rc | σd/d | (Mpa) | (Mpa) | Scratch | (μm) | (μm) | (μm) | ation |
| Example 1 | Resin layer | Impregnation | 54.8 | 112.2 | 0.598 | 0.575 | 525 | 170 | A | 1.55 | 1.62 | 0.07 | A |
| | coating | treatment | | | | | | | | | | | |
| | material 1 | liquid No. 1 | | | | | | | | | | | |
| Example 2 | Resin layer | Impregnation | 55.0 | 109.2 | 0.585 | 0.565 | 510 | 165 | A | 1.53 | 1.61 | 0.08 | A |
| | coating | treatment | | | | | | | | | | | |
| | material 2 | liquid No. 1 | | | | | | | | | | | |
| Example 3 | Resin layer | Impregnation | 59.3 | 129.9 | 0.638 | 0.591 | 515 | 175 | A | 1.51 | 1.60 | 0.09 | A |
| | coating | treatment | | | | | | | | | | | |
| | material 3 | liquid No. 1 | | | | | | | | | | | |
| Example 4 | Resin layer | Impregnation | 54.8 | 112.2 | 0.598 | 0.575 | 515 | 160 | A | 1.49 | 1.62 | 0.13 | A |
| | coating | treatment | | | | | | | | | | | |
| | material 4 | liquid No. 2 | | | | | | | | | | | |
| Example 5 | Resin layer | Impregnation | 60.0 | 139.6 | 0.644 | 0.598 | 505 | 170 | A | 1.56 | 1.71 | 0.15 | A |
| | coating | treatment | | | | | | | | | | | |
| | material 5 | liquid No. 1 | | | | | | | | | | | |
| Example 6 | Resin layer | Impregnation | 59.5 | 80.0 | 0.615 | 0.588 | 530 | 180 | A | 1.53 | 1.69 | 0.16 | A |
| | coating | treatment | | | | | | | | | | | |
| | material 6 | liquid No. 1 | | | | | | | | | | | |
| Example 7 | Resin layer | Impregnation | 59.2 | 150.0 | 0.639 | 0.598 | 490 | 150 | A | 1.54 | 1.69 | 0.15 | A |
| | coating | treatment | | | | | | | | | | | |
| | material 7 | liquid No. 1 | | | | | | | | | | | |
| Example 8 | Resin layer | Impregnation | 75.2 | 142.1 | 0.663 | 0.628 | 500 | 160 | A | 1.54 | 1.75 | 0.21 | B |
| | coating | treatment | | | | | | | | | | | |
| | material 8 | liquid No. 1 | | | | | | | | | | | |
| Example 9 | Resin layer | Impregnation | 77.2 | 147.2 | 0.679 | 0.629 | 370 | 180 | B | 1.63 | 1.89 | 0.26 | B |
| | coating | treatment | | | | | | | | | | | |
| | material 9 | liquid No. 3 | | | | | | | | | | | |
| Example 10 | Resin layer | — | 77.9 | 125.1 | 0.698 | 0.611 | 240 | 235 | B | 1.72 | 2.04 | 0.32 | B |
| | coating | | | | | | | | | | | | |
| | material 10 | | | | | | | | | | | | |
| Example 11 | Resin layer | — | 78.9 | 135.5 | 0.705 | 0.623 | 230 | 225 | B | 1.74 | 2.06 | 0.32 | B |
| | coating | | | | | | | | | | | | |
| | material 11 | | | | | | | | | | | | |
| Example 12 | Resin layer | — | 78.9 | 125.5 | 0.683 | 0.612 | 230 | 225 | B | 1.76 | 2.06 | 0.30 | B |
| | coating | | | | | | | | | | | | |
| | material 12 | | | | | | | | | | | | |
| Example 13 | Resin layer | — | 79.6 | 160.2 | 0.724 | 0.643 | 210 | 205 | B | 1.75 | 2.08 | 0.33 | B |
| | coating | | | | | | | | | | | | |
| | material 13 | | | | | | | | | | | | |
| Example 14 | Resin layer | — | 79.8 | 60.0 | 0.667 | 0.615 | 250 | 245 | B | 1.73 | 2.07 | 0.34 | B |
| | coating | | | | | | | | | | | | |
| | material 14 | | | | | | | | | | | | |
| Example 15 | Resin layer | — | 74.1 | 150.0 | 0.697 | 0.679 | 200 | 200 | B | 1.75 | 2.10 | 0.35 | B |
| | coating | | | | | | | | | | | | |
| | material 15 | | | | | | | | | | | | |
| Example 16 | Resin layer | Impregnation | 54.9 | 114.3 | 0.590 | 0.570 | 525 | 170 | A | 1.32 | 1.36 | 0.04 | A |
| | coating | treatment | | | | | | | | | | | |
| | material 1 | liquid No. 1 | | | | | | | | | | | |
| Comparative | Resin layer | Impregnation | 90.1 | 148.3 | 0.450 | 0.666 | 525 | 170 | A | 1.56 | 2.30 | 0.74 | C |
| Example 1 | coating | treatment | | | | | | | | | | | |
| | material 16 | liquid No. 1 | | | | | | | | | | | |
| Comparative | Resin layer | Impregnation | 91.8 | 143.9 | 0.666 | 0.673 | 510 | 165 | A | 1.52 | 2.30 | 0.78 | C |
| Example 2 | coating | treatment | | | | | | | | | | | |
| | material 17 | liquid No. 1 | | | | | | | | | | | |
| Comparative | Resin layer | Impregnation | 95.6 | 152.3 | 0.677 | 0.658 | 515 | 175 | A | 1.55 | 2.30 | 0.75 | C |
| Example 3 | coating | treatment | | | | | | | | | | | |
| | material 18 | liquid No. 1 | | | | | | | | | | | |
| Comparative | Resin layer | Impregnation | 103.4 | 212.2 | 0.768 | 0.634 | 500 | 155 | A | 1.58 | 2.46 | 0.88 | C |
| Example 4 | coating | treatment | | | | | | | | | | | |
| | material 19 | liquid No. 1 | | | | | | | | | | | |
| Comparative | Resin layer | — | 59.0 | 122.7 | 0.611 | 0.588 | 100 | 100 | C | 1.85 | 2.68 | 0.83 | C |
| Example 5 | coating | | | | | | | | | | | | |
| | material 20 | | | | | | | | | | | | |
| Comparative | Resin layer | Impregnation | 99.2 | 176.2 | 0.686 | 0.680 | 350 | 40 | A | 1.43 | 2.35 | 0.92 | C |
| Example 6 | coating | treatment | | | | | | | | | | | |
| | material 21 | liquid No. 1 | | | | | | | | | | | |

In Examples 1 to 9 and 16, Comparative Examples 1 to 4, and Comparative Example 6, it was confirmed that the crosslinked urethane resin and the crosslinked acrylic resin formed an interpenetrating polymer network structure (IPN) in the first region.

According to the present disclosure, it is possible to provide an electrophotographic roller in which scratches due to abrasion and cracks caused by scratches propagating to the inside can be suppressed even during repeated use in high-temperature and low-temperature environments over a long period of time. Furthermore, according to the present disclosure, it is possible to provide a process cartridge that contributes to the stable formation of high-quality electrophotographic images. In addition, according to the present disclosure, it is possible to provide an electrophotographic image forming apparatus capable of forming high-quality electrophotographic images.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-138958, filed Aug. 20, 2024, which is hereby incorporated by reference herein in its entirety.

What is claimed is:

1. An electrophotographic roller having a conductive substrate and a resin layer on an outer peripheral surface of the substrate, wherein
a thickness of the resin layer is 2.0 to 30.0 μm,
the resin layer comprises a binder resin and carbon black dispersed in the binder resin,
an arithmetic mean value Rc of a circle-equivalent diameter of the carbon black in the resin layer is not more than 80 nm,
an arithmetic mean value d of a distance between wall surfaces of the carbon black in the resin layer is 60 to 170 nm, and
when an elastic modulus of the binder resin in a first region from an outer surface of the resin layer to a depth of 0.1 μm, measured in a cross section in a thickness direction of the resin layer, is defined as E1, E1 satisfies a following formula (1):
$$E 1 \geq 200 MPa . \qquad ( 1 )$$

2. The electrophotographic roller according to claim 1, wherein the binder resin comprises a crosslinked urethane resin.

3. The electrophotographic roller according to claim 1, wherein the resin layer includes at least one compound selected from the group consisting of a compound having a structure represented by a following structural formula (2), a compound having a structure represented by a following structural formula (3), and a compound having a structure represented by a following structural formula (4): 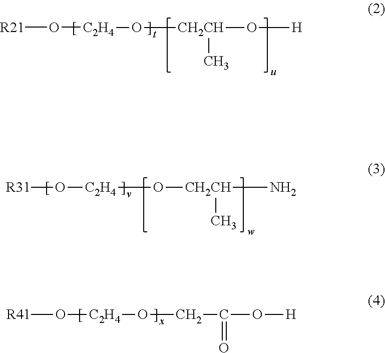
in structural formula (2), R21 represents a monovalent hydrocarbon group having 1 to 12 carbon atoms, and t and u are average numbers of moles added, each of which independently represents a number of at least 1;
in structural formula (3), R31 represents a monovalent hydrocarbon group having 1 to 8 carbon atoms, and v and w are average numbers of moles added, each of which independently represents a number of at least 1; and
in structural formula (4), R41 represents a monovalent hydrocarbon group having 1 to 12 carbon atoms, and x is an average numbers of moles added and represents a number of at least 1.

4. The electrophotographic roller according to claim 1, wherein
E1 is at least 250 MPa, and
when an elastic modulus of the binder resin in a second region from the outer surface of the resin layer to a depth of 1.0 to 1.1 μm is denoted by E2, E2 is 120 to 200 MPa.

5. The electrophotographic roller according to claim 1, wherein
the resin layer comprises a crosslinked urethane resin and a crosslinked (meth)acrylic resin, and
the crosslinked urethane resin and the crosslinked (meth)acrylic resin form an interpenetrating polymer network structure in the first region.

6. The electrophotographic roller according to claim 1, wherein the binder resin comprises a crosslinked urethane resin, and
the crosslinked urethane resin has a polycarbonate structure.

7. The electrophotographic roller according to claim 1, wherein
the arithmetic mean value Rc of the circle-equivalent diameter is not more than 60 nm,
when a standard deviation of the circle-equivalent diameter is denoted by σc, σc/Rc is 0.000 to 0.650,
the arithmetic mean value d of the distance between the wall surfaces is 80 to 150 nm, and
when a standard deviation of the distance between the wall surfaces is denoted by σd, σd/d is 0.000 to 0.600.

8. The electrophotographic roller according to claim 1, wherein
a number-average diameter of primary particles of the carbon black is not more than 30 nm,
a DBP absorption amount of the carbon black is not more than 90 mL/100 g, and
a pH of the carbon black is not more than 4.0.

9. A process cartridge configured to be detachably attached to a main body of an electrophotographic image forming apparatus, wherein
the process cartridge has the electrophotographic roller,
the electrophotographic roller has a conductive substrate and a resin layer on an outer peripheral surface of the substrate,
a thickness of the resin layer is 2.0 to 30.0 μm,
the resin layer comprises a binder resin and carbon black dispersed in the binder resin,
an arithmetic mean value Rc of a circle-equivalent diameter of the carbon black in the resin layer is not more than 80 nm,
an arithmetic mean value d of a distance between wall surfaces of the carbon black in the resin layer is 60 to 170 nm, and
when an elastic modulus of the binder resin in a first region from an outer surface of the resin layer to a depth of 0.1 μm, measured in a cross section in a thickness direction of the resin layer, is defined as E1, E1 satisfies a following formula (1):
$$E 1 \geq 200 MPa . \qquad ( 1 )$$

10. An electrophotographic image forming apparatus comprising: an image bearing member for bearing an electrostatic latent image; a charging roller for primarily charging the image bearing member; and a developing roller for developing the electrostatic latent image with toner to form a toner image, wherein
either or both of the charging roller and the developing roller are an electrophotographic roller having a conductive substrate and a resin layer on an outer peripheral surface of the substrate,
a thickness of the resin layer is 2.0 to 30.0 μm,
the resin layer comprises a binder resin and carbon black dispersed in the binder resin,
an arithmetic mean value Rc of a circle-equivalent diameter of the carbon black in the resin layer is not more than 80 nm,
an arithmetic mean value d of a distance between wall surfaces of the carbon black in the resin layer is 60 to 170 nm, and
when an elastic modulus of the binder resin in a first region from an outer surface of the resin layer to a depth of 0.1 μm, measured in a cross section in a thickness direction of the resin layer, is defined as E1, E1 satisfies a following formula (1):
$$E 1 \geq 200 MPa . \qquad ( 1 )$$
